(19) United States
(12) Patent Application Publication
(10) Pub. No.: US 2010/0145743 A1
(43) Pub. Date: Jun. 10, 2010

(54) SYSTEMS AND METHODS FOR ENVIRONMENTAL CURRENCY PURCHASING AND TRACKING

(76) Inventor: Allan Bruce Colquhoun, Toronto (CA)

Correspondence Address: Allan Colquhoun, 104 Woodbine Ave, Toronto, M4L2A2, omitted

(21) Appl. No.: 12/630,416

(22) Filed: Dec. 3, 2009

Related U.S. Application Data
(60) Provisional application No. 61/119,960, filed on Dec. 4, 2008.

(51) Int. Cl. G06Q 50/00; G06Q 10/00; G06F 17/00; G06Q 30/00; G06Q 20/00; G06Q 99/00; G06F 3/01

(52) U.S. Cl. 705/5; 700/236; 700/237; 705/27; 705/30; 705/317; 715/733

(57) ABSTRACT

There is a system for carbon offsetting a travel product comprising a system provider server configured to provide one or more user screens to one or more computing devices used by a user of the travel product, a travel provider of the travel product or a carbon offset sponsor of the travel product, allow selection of a travel product by one or more of the computing devices through interaction with one or more user screens of the system provider server, arrive at the environmental currency required by the travel product, receive, from one or more of the computing devices, environmental currency, or value used to purchase environmental currency for the travel product, and add the received or purchased environmental currency to a total of received environmental currency for the travel product.

### CROSS-REFERENCE TO RELATED APPLICATION

This application claims the benefit of Provisional Application No. 61/119,960, filed Dec. 4, 2008; the contents of 35 which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The environment is becoming more and more of a concern. People are becoming more environmentally conscious and are increasingly making “green” choices—choices that are better for the environment than choices they could make.

Many areas of life have environmental impact and to varying degrees these impacts are either not understood, not given enough consideration, or are difficult to monitor and change. There may be some ways to monitor impacts, minimize impacts and attempt to reverse (such as through purchasing environmental currency such as emissions, carbon offsets and the like) environmental impact that may include energy use, greenhouse gas emissions, paper and garbage use etc.

One area of life that has a large environmental impact is travel. Whether by car, bus, airplane or otherwise, many forms of travel have deleterious environmental impacts. Such impacts can be severe.

Purchasing carbon offsets for flights, and some other travel products, is now possible. This allows a person or organization to voluntarily acquire carbon offsets that may be applied to the carbon footprint they cause by traveling.

The following systems and methods are aimed at systems and methods for environmental currency purchasing and tracking such as carbon offsets.

### SUMMARY OF THE INVENTION

In a first aspect of the invention there is a vending machine for purchasing an environmental currency product comprising a payment acceptor and a vending machine user interface for selecting an environmental currency product to purchase. The vending may further provide an acknowledgement of the carbon offset product purchased. The environmental currency product may be a carbon offset product and the acknowledgment may be a carbon offset product identifier that may be in human readable form or computer readable form and may be removed from the vending machine by a purchaser. The vending machine user interface further allows one or more identifiers to be entered that may allow tracking of travel information by one or more of a system provider or a travel provider. The vending machine may further comprise a communication interface for sending and receiving data. The communication interface may send a received payment and an identifier to a system provider and may effect the purchase of the carbon offset product selected and receives an acknowledgement of the carbon offset product purchased. The communication interface may send travel information to one or more of a travel provider or system provider.

In another aspect of the invention there is a vending machine for purchasing an environmental currency product comprising a vendable product holder that can hold one or more vendable products, one or more payment acceptors, a vendable product dispenser, and a user interaction device to facilitate a user purchasing a vendable product to be dispensed to the user via the vendable product dispenser by providing payment to the vending machine via the payment acceptor. The vendable products may comprise a carbon offset card (COC). The vending machine may further comprise a vendable products acceptor for reading one or more datasets from the vendable product. The vendable products acceptor may comprise a reader/writer configured to read/write one or more datasets from or to the vendable product. The vendable product may be redeemed or activated for the purchase of a carbon offset product, and the redeeming may be performed by the vending machine upon purchase or by providing a vending product identifier to one or more of a system provider, environmental certifier or travel provider.

In another aspect of the invention there is a system for environmental currency purchasing and tracking comprising a vendable product configured to store value and travel information, one or more vending machines configured to dispense vendable products, redeem value from the vendable product and provide travel information to the vendable product. The system may further comprise a system provider that may communicate with the vending machine. The system may further comprise an environmental certifier, wherein the vending machine may be configured to provide redemption information to the environmental certifier and the environmental certifier may purchase the environmental currency from an environmental currency provider. The environmental currency may be carbon offsets and the environmental currency provider may be a company that provides carbon offset products. The system may further comprise a travel provider that may provide travel information about travel products it offers. The travel provider, system provider, vending machine and environmental provider may exchange data. The data exchanged may allow one or more of purchasing of environmental currency products, tracking of travel information, and advertising opportunities.

In a further aspect of the invention there is a vendable product configured for reading by a vendable product reader, the vendable product comprising stored computer-readable signals representing travel information data. The stored computer-readable signals may further comprise a stored value or travel provider loyalty points. The travel information may comprise one or more travel products that have been purchased, one or more travel providers for the one or more travel products, and one or more amounts of carbon offsets redeemed relating to one or more travel products that have been purchased. The vendable product may further comprises one or more vendable product identifiers to identify one or more of the vendable product or a user of the vendable product. The vendable product may comprise a carbon offset card (COC). The vendable product may be configured for being written to by a vendable product writer or may allow an associated account to be written to and may write or alter at least one or the travel information data, the stored value, or travel provider loyalty points.

In another aspect of the invention there is a method for checking in for a travel product comprising obtaining check-in information from a customer, querying whether carbon offsets are to be purchased, facilitating the purchasing of carbon offsets, capturing travel information and completing check-in. The method may be performed on one or more self check-in terminals. Asking may further comprise specifying the value of the carbon offsets required. Facilitating may further comprise accepting cash, credit card, debit card or carbon offset card payment. The method may further comprise disseminating travel information to one or more of travel providers or system provider.

In another aspect of the invention there is a method for carbon offsetting a travel product comprising obtaining information about carbon offset products purchased by one or more customers of the travel product. The method may further comprise receiving information about carbon offset products purchased by one or more sponsors of the travel product. The obtaining may occur before the travel product departs and during the duration of the travel product. The receiving may occur before the travel product departs and during the duration of the travel product. The method may further comprise contributing, by a travel provider offering the travel product, carbon offset products purchased by the travel provider. The obtaining may occur by one or more vending machines or computing devices providing information captured from one or more customers or travel provider employees.

In another aspect of the invention there is a system for carbon offsetting a travel product comprising a system provider server that may be configured to provide one or more user screens to one or more computing devices used by a user of the travel product, a travel provider of the travel product or a carbon offset sponsor of the travel product, allow selection of a travel product by one or more of the computing devices through interaction with one or more user screens of the system provider server, arrive at the environmental currency required by the travel product, receive, from one or more of the computing devices, environmental currency, or value used to purchase environmental currency for the travel product, and add the received or purchased environmental currency to a total of received environmental currency for the travel product. The system provider server may further comprise one or more travel product data records that comprise datasets that indicate what portion of a travel product has been offset by purchased environmental currency. The system provider may further comprise one or more user travel information data records, each relating to one or more users, that indicate whether a user has selected the travel product and whether a user has purchased environmental currency to offset the travel product, or a portion thereof, and wherein the system provider is configured to receive value from the user to purchase environmental currency and include an indication of such purchase in the user travel information data record. The system provider server may be further configured to provide one or more user screens to one or more computing devices that indicates the environmental currency required by the travel product and the environmental currency received for the travel product. The system provider server may be further configured to provider one or more user screens to one or more computing devices that indicates the environmental currency purchased by a user to offset the travel product, the environmental currency purchased by a travel provider to offset the travel product and the environmental currency purchased by a carbon offset sponsor to offset the travel product. The system may further comprise one or more travel provider travel information data records, each record relating to one or more travel providers, that indicate whether the travel provider has purchased environmental currency to offset a travel product, or a portion thereof and wherein the system provider is configured to receive value from a travel provider to purchase environmental currency and include an indication of such purchase in the travel provider data record, and one or more carbon offset sponsor data records, each record relating to one or more carbon offset sponsors, that indicate whether carbon offset sponsor has purchased environmental currency to offset a travel product, or a portion thereof and wherein the system provider is configured to receive value from a carbon offset sponsor to purchase environmental currency and include an indication of such purchase in the carbon offset sponsor data record. The user screens may be provided to one or more computing devices prior to the travel product departing, during the travel product or after the travel product is completed or finished.

In another aspect of the invention there is a method for checking in for a travel product comprising obtaining check-in information from a customer of the travel product, querying whether environmental currency is to be purchased, facilitating the purchase of environmental currency, capturing travel information and completing check-in. Querying may comprise determining whether the required amount of environmental currency for the travel product, or a user's portion thereof, has been purchased and determining who the purchaser is and if it has not then asking a user if they wish to purchase environmental currency. Completing may further comprise providing the user a boarding pass wherein the boarding pass has an advertisement for the purchaser of the environmental currency.

In another aspect of the invention there is a method for purchasing a travel product comprising receiving parameters for the desired travel product, returning one or more travel products matching the received parameters, displaying whether the required amount of environmental currency for each of the one or more travel products, or a user's portion thereof of each of the one or more travel products, has been purchased, obtaining a selection of a travel product to purchase, and receiving payment in exchange for the travel product. The method may further comprise querying whether environmental currency is to be purchased and facilitating the purchase of environmental currency.

Embodiments of this invention are further discussed herein below.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic diagram of an embodiment of a vending machine according to the invention;

FIGS. 2A-B are diagrams of embodiments of user interfaces for a vending machine according to the invention;

FIGS. 3-5 are diagrams of an embodiment of user interfaces according to the invention;

FIGS. 6A-B are schematic diagrams of the front and back of an embodiment of a vendable product according to the invention;

FIG. 7 is a schematic diagram of an embodiment of a system for environmental currency purchasing environmental currency according to the invention;

FIG. 8 is an embodiment of a method for checking in for a travel product according to the invention;

FIG. 9 is an embodiment of a method for buying a travel product according to the invention;

FIGS. 10A-B are exemplary data records according to the invention; and

FIGS. 11A-C are exemplary user screens according to the invention.

### DETAILED DESCRIPTION OF THE INVENTION

Overview

Embodiments of the systems and methods according to the present invention may allow environmentally-conscious entities (customers, companies, etc) to purchase, track and monitor environmental currency, for example, their carbon offsets for the travel they take. Such systems and methods may further allow travel providers 714 to similarly track and monitor the extent to which their travel products (flights etc) are carbon offset, and may allow corporate sponsors and advertisers the opportunity to carbon offset portions of such travel products.

Embodiments of the systems and methods according to the present invention may allow environmental currency such as carbon offsets, to be purchased easily and quickly using cash, COC 12, a credit card or a debit card—even after arrival in an airport, gate, or airplane.

Embodiments of the systems and methods according to the present invention may allow tracking of travel information, including carbon offsets purchased, for one or more different travel providers.

Embodiments of the systems and methods according to the present invention may allow incentives to be offered to customers and travel providers 714 who offset their travel products and may allow customers, travel providers 714, sponsors and other entities to contribute to carbon offsetting travel products.

Vendable products 12 may be purchased (or provided) and used to purchase, redeem and/or track such travel products and carbon offsets. As with other card-based programs (credit and debit cards, library cards, gym cards, etc), users may find this a convenient approach, and the systems and methods described herein may be implemented in a convenient and cost-effective way with such vendable products. Vendable products 12 may also be for one-time use and may allow tracking but not be used for such. Any tracking may be in conjunction with one or more travel providers 714, relate to one or more travel providers' travel products, or be performed substantially by one or more travel providers 714.

However, such vendable products may be supplemented by or exchanged for user accounts (and the like), which may be a simple way to maintain the ability to perform the functionality of the embodiments of the present invention.

Further, aspects of the present invention may allow carbon offsetting and environmental responsibility to become a regular consideration when deciding what travel to take, with what travel provider and what services to use in a destination city. It may allow carbon offsetting and environmental responsibility to become a regular step when checking in for flights. It may allow carbon offsetting and environmental responsibility to be part of a travel provider's differentiation from its competitors as more of its flights are carbon neutral. It may allow corporations to meaningfully demonstrate their commitment to environmental responsibility while deriving increased goodwill through advertising. It may allow cross-promotions between travel providers, corporations, and service-providers (restaurants, car rentals, hotels) in destination cities who are willing to join together to be environmentally responsible and provide responsible choices for travel product users. In effect, all phases of a user's travel should result in them asking “what is the most environmentally responsible way?”, “what travel provider has been responsible, thus deserving my support?”, “will my sales director, or my organization, do their part by offsetting my flights?” and “what company or companies have contributed to environmental responsibility through offsetting flights?”.

Regardless of various implementation details, the present invention provides systems and methods for environmental currency purchasing and/or tracking, such as relating to carbon offsets.

Exemplary Uses of the Systems and Methods Described Herein

To assist in understanding the systems and methods described herein, some exemplary uses of these systems and methods are described at the beginning. It is to be understood that these are merely exemplary embodiments and are not intended to limit the scope of the present invention as described herein.

In one embodiment, a customer may have an account with system provider 706 and one or more accounts with one or more travel providers 714. These may be connected or associated by system provider 706 in a database in data stores 710 or elsewhere. One or more vending machines 10 or redemption terminals 720 may be located in airport gates. Such VM 10 and redemption terminal 720 accept one or more of credit card, debit card, stored value card (such as COC 12) and cash payments for the purchase of carbon offset products. One or more of the user's accounts' information may be captured (such as via screens 300 as described herein or from COC) when they make such a purchase. Travel information can then be tracked, such as carbon offsets the user has purchased. This may be done at the system provider level (which could track one or more travel providers 714 and may track substantially all of the user's travel) or travel provider level (which could track the carbon offsetting for a particular airline, for example). The entity responsible for various aspects of this embodiment may vary depending on the level of integration with one or more travel providers 714 and the degree to which they currently offer the ability to offset carbon footprints. Other features, as described herein, may further be offered.

In another embodiment, self check-in stations may be used. When a user arrives at the airport to check in, they may proceed to check in substantially as in the past. However, they may further have the option of purchasing carbon offsets as they check in. This may be via one or more screens or web pages, as described herein. Customers may pay via providing their SPCI (entering it manually or having it accessed from COC 12), possibly with a password for security purposes (providing they have enough value associated with that account). They may also pay via another account with travel provider 714 or by entering their credit card information, or using the credit card on file or used to purchase the travel product. Having purchased a carbon offset, tracking of travel information may be enabled based on providing the customer's SPCI, using their passport number, SPPCI, or any other identification. Such travel information may be disseminated to system provider 706 and/or other aspects of travel provider 714, depending on the degree of integration. Travel provider 714, whose self check-in station is being used, may simply allow one or more screens 300 to be displayed to a user who wants to purchase and track travel information. System provider 706 may then provide the screens and take care of all processing to effect purchase and tracking—returning the user to travel provider 714 screens used on self check-in station when such is complete. Such a check in procedure may result in a boarding pass being issued to the user. Such boarding pass may be altered due to the purchase of the environmental currency, or carbon offset product, by any of a user, the travel provider, or a corporate sponsor. The alteration may indicate that the travel product for that user has been offset and may indicate the party that provided the environmental currency. This may take the form of a logo, advertisement, different color portion (such as green) or any other way to alter the boarding pass. Such alteration or indicator may, for example, make the fact that carbon offsets have been purchased by that user more easily known to other people, for example in the airport or at the user's gate.

In yet another embodiment, VM 10, redemption terminal 720, or computing devices controlled by travel provider 714 may read boarding passes and allow a customer to purchase a carbon offset for the flight related to such boarding pass. Reading the boarding pass may provide VM 10 one or more of the customer's accounts—based on their name, seat number, or other information (this information may be looked up in travel provider 714 databases, for example, which may include a record of the person seated in a particular seat and may have already associated SPPCI with such person/seat). They may then purchase a carbon offset (the cost or value of which may be suggested by VM 10, redemption terminal 720, or computing devices controlled by travel provider 714 based on their destination) via a debit card, cash, credit card (such as one that is one file or that was used to purchase the ticket that resulted in the boarding pass) or by COC 12.

In one embodiment, vending machine 10 may be located in an airport, for example in a departure terminal, gate, check-in desk operated by travel provider 714, or connected to or part of a self-serve kiosk for checking in. A user that may be about to take a flight may not currently have COC 12. The user may choose to purchase COC 12 at vending machine 10. A user may select to purchase COC 12 that has the required offset for the flight they are about to take. This value may be measured in dollars, “trees”, miles, tons or any other form, as described herein. In an alternate embodiment, a user may purchase COC 12 with a value and immediately redeem the value for the flight (such as by selecting a specific flight number) or destination they are going to (such as by selecting Ottawa, where vending machine 10 or system provider 706 may already know that the user is located in, for example, Toronto's Island Airport or Pearson Airport, and be able to determine what value to redeem). In an alternate embodiment, a user may purchase COC 12 with the desired value on it at VM 10 and redeem the carbon offset value for the flight they are taking to Ottawa, at a further redemption terminal 720 as described herein. It is to be understood that the value purchased may be for a one-way trip or a round-trip and may be for any fraction of such one-way or round-trip ticket or flight.

Vending machine 10 or redemption terminal 720, and the ability to offset the carbon impact of a user's flight, may be combined with another kiosk, such as a self-serve kiosk for checking in. In such case, a user may identify themselves to the kiosk (such as by providing their passport for scanning or other methods as are known in the art). The user may perform other tasks relating to checking in such as selecting a seat or entering Air Miles™ information. The user may further provide COC 12 or vendable product identifier 606a/606b, allowing them to redeem at least some of the value to offset the flight they are going to take.

Vending machine 10 and/or redemption terminal 720, and the ability to offset the carbon impact of a user's flight, may be combined with one or more machines and systems located at each gate in an airport. In such an embodiment, a user may purchase COC 12 or preferably may already have COC 12. When a user provides their boarding pass to proceed through the gate to the airplane, they may also redeem value from their COC 12 to offset their flight. This may be done by providing their COC 12 to vending machine 10 and/or redemption terminal 720. Alternatively, COC 12 and vending machine 10 and/or redemption terminal 720 may be configured to communicate based on their proximity (such as via RFID or other techniques known to those of skill in the art), or by touching a pad that may be magnetized. The user may be able to specify whether they want to offset their one-way trip, their round-trip, or fractions of one or more legs of their trip—such as 50% of each leg of their round-trip. Vending machine 10 and/or redemption terminal 720 may ensure that COC 12 has sufficient value stored thereon. This may be accomplished, for example, with system provider 706.

In any of the embodiments described herein, value stored on COC 12 may also be stored, possibly in duplicate or solely, with system provider 706. Therefore, if a user forgets their COC 12 they may still redeem value, such as by providing COC 12 identifier, their name, or other identifying information, to vending machine 10 and/or redemption terminal 720. This also may increase the accuracy and security of the data. Vending machine 10, redemption terminal 720 and COC 12 may conform the accurate value between them. For example, if a user redeems value from COC 12 at redemption terminal or vending machine 10 and they are not able to communicate immediately with system provider 706 then they may store such redemption information (such as the COC identifier, flight number, date, time, and other information) and communicate it when they are able to.

By way of example, redemption terminal 720 or vending machine 10 may be on the airplane (which may convince or cause one or more further people to redeem value and offset their portion of the flight, for example to make the entire flight carbon offset or carbon neutral). In such a case, redemption terminal 720 or vending machine 10 may not be able to communicate to system provider 706 at that time (or may be configured not to, for example to not interfere with the airplane's communication systems). Redemption terminal 720 or vending machine 10 may, at a later time, communicate the redemption, such as when the plane reaches the next airport or returns to the departure airport. Redemption terminal 720 or vending machine 10 may also be moveable or portable, such that, for example, they can be at the gate and then moved onto the plane, and subsequently taken off the plane upon landing. Each plane may have their own one or more redemption terminals 720 or vending machines 10.

Alternatively, each organization or group (such as a large company, one with a private plane, or a sports team) may have their own one or more redemption terminals 720 or vending machines 10, or COC 12, that may allow them to monitor whether they travel in a carbon neutral manner. Alternatively, such groups may access one or more screens 300 from system provider 706. This may be via a PC and an HR or travel employee or provider. Such screens 300 may allow carbon offsets to be purchased for any travel product and any travel providers 714.

Having redemption terminal 720 or vending machine 10 on an airplane may allow for other redemption opportunities. In one embodiment, a carbon offset sponsor (such as travel provider 714, corporate sponsor, a private individual, or any other party) may desire that a particular flight be carbon neutral and/or all passengers to have offset their carbon footprint. Such carbon offset sponsor may be willing to make up any shortfall to achieve carbon neutrality. However, until the airplane is fully boarded there may be no way to tell if the flight is carbon neutral and/or all passengers have offset their carbon footprint. After the plane is boarded, a sponsor could specify to have any shortcomings covered (although they may also sponsor prior to boarding). An announcement may then be provided to the passengers that the sponsor has ensured that the flight is carbon neutral.

Vending Machine for Vendable Products/COC

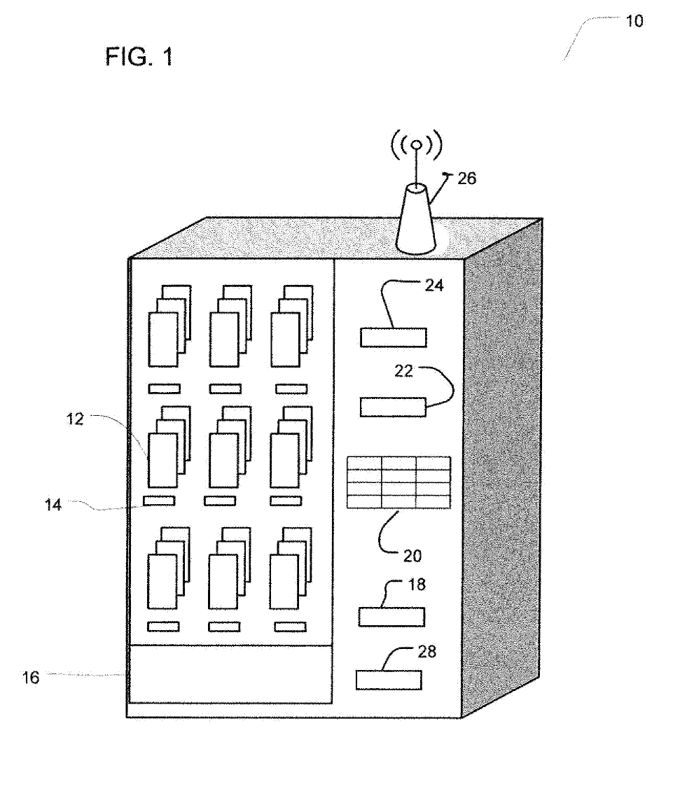

FIG. 1 is a schematic diagram of an embodiment of vending machine (VM) 10 according to the invention. Vending machine 10 comprises vendable products 12, vendable products information 14, vendable products dispenser 16, vendable products acceptor 18, vending machine user interface (VMUI) 20 (which may be a vending machine user interaction element (VMUIE) such as a knob, button or other mechanical or computer elements that allow a user to select or purchase a vendable product), money acceptor 22, payment card acceptor 24, communication interface 26, and printer 28.

Vending machine 10 may allow a customer or other user to purchase one or more vendable products 12, add value to one or more vendable products 12, redeem value from one or more vendable products 12, obtain and view information that may relate to travel information, send information such as travel information and financial information, and check the value stored on vendable product 12.

It is to be understood that the terms “user”, “customer”, “traveler”, and “passenger” are being used substantially interchangeably herein, unless indicated otherwise. Further, such terms may include individuals, companies, organizations, government agencies, and sports teams.

As will be described herein, purchasing may include both vendable product 12 and value that may be stored on vendable product 12 (ie a purchase may include obtaining vendable product 12 that has an initial stored value thereon). The value of vendable product 12 and the environmental currency may be based on one or more criteria such as money (in any value unit, such as USD, Euros, Canadian dollar, Yen etc), carbon offsets (such as tons, which may be convertible into a monetary amount), carbon offset units (such a one “star” or “tree” on a scale of five “star”s or ten “tree”s—which may be convertible into a monetary amount), or any other criteria. The value of a vendable product 12 may be described in terms of distances or cities traveled in a particular mode of travel (such as airplane or car). By way of example, vendable product 12 may have an environmental currency of Ottawa-Toronto (roundtrip or 1-way), and may cost $5.00 to purchase.

Purchasing or adding value may occur, for example, by inserting money into money acceptor 22, a credit or debit card into payment card acceptor 24, or by providing credit information in a manner other than through vending machine 10 and having such credit information be provided to vending machine 10 to allow purchasing. In one exemplary embodiment, credit information, which may include a monetary amount and a vendable products identifier 606a/606b, may be provided via a web page or web site using a cellular telephone or personal computer. The web page may authenticate the transaction (as is known in e-commerce and with e-commerce web sites) and provide the credit information to vending machine 10 which may allow application of that credit to vendable products 12 having the right vendable products identifier the next time that vendable products 12 is provided to vending machine 10. It is possible that no vendable product is needed and an account or profile is simply updated with the purchase. Alternatively, printer 28 may provide a vendable product 12, which may substantially be a piece of paper with one or more datasets printed thereon—such as vendable products identifier 606a/606b.

Redeeming value may occur at the same time as purchasing or may occur at a later time and/or location. Redeeming may comprise “spending” at least a portion of the stored value on vendable products 12. Redeeming may comprise selecting a product, service or activity that stored value can be used for and applying stored value thereto. In one embodiment, redeeming may comprise selecting an airplane flight that a customer or user is going to take and applying carbon offsets stored on vendable products 12 to offset at least a part of the airline flight, such as a user's portion of the carbon impact of the flight. Redeeming may involve activating vendable product 12, which may be caused by providing information about vendable product 12 (such as vendable products identifier 606a/606b) to one or more components of system 700, such as system provider 706 or environmental certifier 702.

As used herein, carbon offsets will be used as an example of an environmental currency. Other environmental currencies may include carbon taxes, carbon tax credits, greenhouse gas emission offsets, global emissions credit trading, tree-replanting, electrical useage, garbage dump contributions and the like. Although the present invention describes systems and methods that may relate to carbon offsets, such systems and methods may be equally applicable to other environmental currencies. By way of example, a user may monitor their greenhouse gas emissions and purchase and track the greenhouse gas emission offsets or credits that they purchase. This may allow them to determine and monitor whether they have a neutral greenhouse gas emission.

Obtaining and viewing travel information may comprise accessing one or more sources of travel information and displaying at least a portion of travel information, or related information, on VMUI 20. Such may be from external sources, VM 10 or vendable products 12 for example. This may involve accessing one or more sources of travel information from one or more travel providers 714 (such as airlines, bus companies, limousine services, car rental companies, railway companies and boat companies), such as airline information sources (web sites, newsfeeds, databases etc) that have flight information from one or more airlines or may involve accessing a central repository that amalgamates many sources of travel information (such as from multiple airlines, bus companies, gas stations or companies).

Travel information may comprise information about flights, bus schedules, train schedules, gas and car information, carbon offset information relating to flight, buses, trains and cars (such as how much carbon offsetting would be required to offset at least a portion of a flight, bus ride, tank of gas for a car or bus, etc). Travel information may further comprise specific information relating to a user's travel or travel products, such as the travel they have taken or travel products they have purchased (flight numbers and dates for example), the amount of carbon offset they redeemed or purchased for the travel (such as in dollars or percentages), and statistics about the total amount of carbon offsetting they have done for the travel.

Exemplary tables of a user's specific travel information are found below, noting that such information may not necessarily be stored as a table on vendable product 12 or elsewhere, such as in data stores 710.

| | |
|---|---|
| Vendable product | 12ABC#29 |
| identifier And/Or | |
| SPCI | |
| User Name | Joe Smith |
| Corporate Name | ABC Inc. |
| Corporate | Sales and Marketing |
| Department | |
| Contact Information | 123 Main St., ThisTown, Ont, Canada |
| | 123-456-7891 |
| | joesmith@mymail.com |

| | | | Travel | | | | Carbon | Vendable |
|---|---|---|---|---|---|---|---|---|
| | Travel | Travel | Product | Departure | Destination | Carbon | Offset | Products |
| Date | Provider | Product | Vehicle | Location | Location | Footprint | Purchased | ID |
| 2- | Porter | 259 | Bombardier | Toronto | Ottawa | 12 tons | 100% | YYZYOW |
| Nov- | Airlines | | Q400 | | | | | 2WF12345 |
| 08 | | | | | | | | |
| 4- | Porter | 262 | Bombardier | Ottawa | Toronto | 12 tons | 100% | YYZYOW |
| Nov- | Airlines | | Q400 | | | | | 2WF12345 |
| 08 | | | | | | | | |

Sending information may comprise sending data to one or more sources external to vending machine 10. Sending may be performed by communication interface 26. Data that may be sent may include travel information and/or financial information from VM 10 or vendable product 12. Data may be sent to one or more recipients of travel information, such as airlines or bus companies' web sites, newsfeeds, databases etc that have flight information or may involve accessing a central repository that amalgamates travel information (such as from multiple airlines, bus companies, gas stations or companies). In one embodiment, when a user redeems stored value for a flight they are going to take, vending machine 10 sends the redemption information to an airline source or amalgamation system (such as a third party server like travel provider 714) that may track various statistics, such as how much the flight has been carbon offset or how many passengers or travelers have offset their flight, and how many flights a passenger has taken and how much of each has been carbon offset. Such statistics may be tracked by or at one or more of vendable products 12 or an airline source or amalgamation server.

Checking the value of vendable products 12 may comprise indicating to a user of vending machine 10 how much value is stored on vendable product 12. Value may be measured based on one or more criteria, such as money (in any value unit, such as USD, Euros, Canadian dollar, Yen etc), carbon offsets (such as in tons, which may be convertible into a monetary amount), carbon offset units (such a one “star” or “tree” on a scale of five “star”s or ten “tree”s—which may be convertible into a monetary amount), the number of flights that could be offset, or any other criteria. Indicating to a user may be in any way, such as an audible or tactile indication, or may be visually such as using VMUI 20, by sending a text message or email, or printing the value using printer 28.

VM 10 may be connected to a communication network (not shown) to allow sending and receiving data. Such connection may be via communication interface 26. Vending machine 10 may be able to receive data from a server computer and send data to a server computer (such as system provider 706, environmental certifier 702, or travel provider 714). Such sending and receiving data may allow travel information to be exchanged and may allow a user interface to be presented on vending machine 10. In one exemplary embodiment, vending machine 10 may receive one or more web pages, or user screens, via a communication network and display them on VMUI 20. Such web pages may include travel information and may be substantially similar to web pages that may be viewed on a computing device such as a cellular telephone, personal computer, or laptop computer. Such web pages may further include one or more advertisements. Such advertisements may relate to corporate sponsors (as described herein), travel providers 714, environmental certifier 702, environmental issues or awareness groups, and other advertisers that may wish to advertise and be associated with such an environmental movement.

Vendable products 12 may allow data to be displayed thereon or stored thereon. Such data may include carbon offset data, environmental data, advertising data, travel information, financial data such as the value stored on vendable products 12, statistical data relating to one or more users of vendable product 12, the user's company (such as if a corporation or other entity tracks the carbon offsetting of its workforce such as its salespeople or other business people), or sponsors of one or more of vending machine 10, a user, a user's company, or a travel provider 714 (such as an airline or bus company).

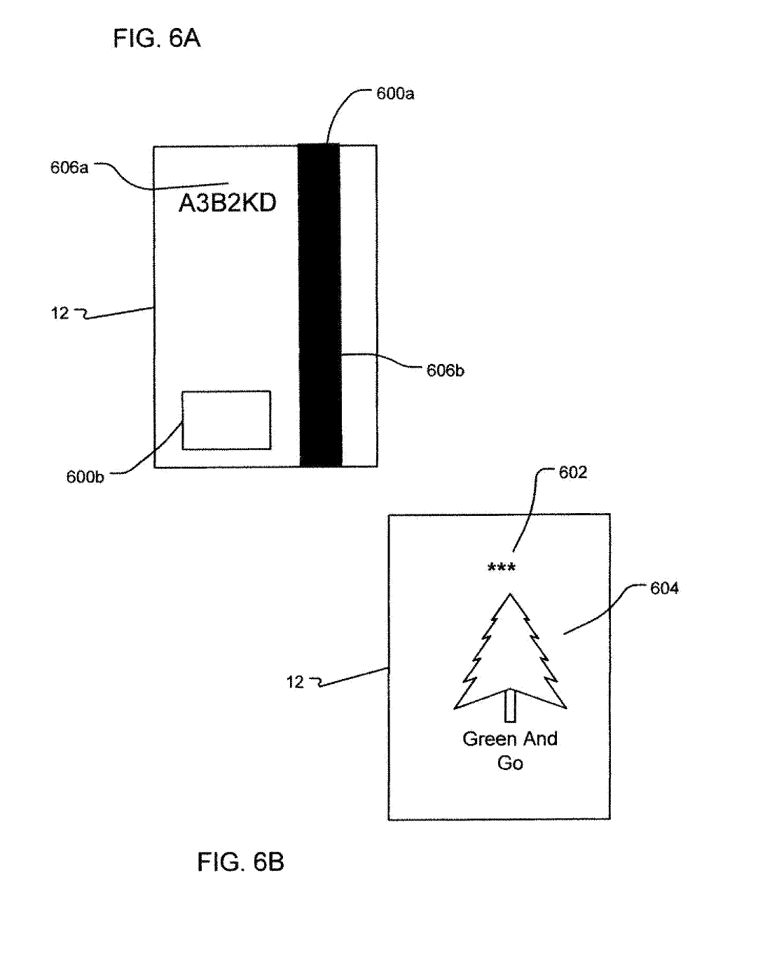

Vendable product 12 may be, for example, a stored value card (open-loop, closed-loop or some combination) such as shown in FIG. 6 and may be referred to as a carbon offset card (COC). Vendable product 12 may be made out of recycled material and/or made in an environmentally friendly way. Vendable product 12 may be a piece of paper that may have writing thereon that may include data. Vendable product may be substantially similar in construction to a credit card or debit card.

Vendable product 12 may be a piece of paper. This may be a receipt provided by printer 28, a pre-printed paper, or may be glossed paper of some sort, similar to a scratch and win lottery ticket.

Vendable product 12 may simply be purchased, redeemed or activated, and then discarded or not otherwise used for tracking or storing data thereon. For example, a user may purchase vendable product 12, scratch off an area that may obscure a vendable product identifier, allowing a user to, for example, redeem or activate vendable product 12 via a web page or telephone system. This activation or redemption may cause environmental certifier 702 to purchase, for example, the carbon offset from a carbon offset provider. An acknowledgement may be provided back to a user. Such acknowledgment may indicate success purchase and may be accomplished in any way, such as an audible or tactile indication, or may be visually such as using VMUI 20, by sending a text message or email, or printing the value using printer 28.

In another embodiment, when a user purchases vendable product 12, vending machine 10 may initiate the redemption or authorization, such as via environmental certifier 702, and this may be done using communication interface 26 such as via web-based communication. These approaches may substantially allow a user to purchase and redeem vendable product 12 (substantially simultaneously) but not track such purchase and redemption, unless the user does so themselves.

Vendable products information 14 may be any information relating to vendable products 12. Vendable products information 14 may include pricing information for one or more vendable products 12 (which may be in any currency as described herein), travel information, carbon offset information, a destination city that vendable product 12 will provide an offset to, and any other information relating to environmental information or data.

Vendable products information 14 may be displayed in vending machine 10 and may be affixed therein in any fashion. Vendable products information 14 may be optional.

Vendable products dispenser 16 may allow vendable products 12 to leave, be dispensed, or be removed from vending machine 10. This may occur after payment.

Vendable products acceptor 18 may accept vendable product 12 back into vending machine 10, be slid along VM 10, or otherwise read by VM 10 (as VM may be a vendable product reader). This may be to return vendable product 12 or to top-up or add value to vendable product 12. Vendable products acceptor 18 may be a reader of vendable product 12, allowing stored computer-readable signals to be read, such as signals representing travel information data.

Money acceptor 22 may be any one or more manners by which vending machine 10 can accept cash currency such as paper bills and/or coins. Money acceptor 22 may allow a user to insert cash currency and may be involved in determining how much cash currency was deposited, and other related functions to facilitate one or more of the transactions that vending machine 10 may perform. Similarly, payment card acceptor 24 may perform similar functions for card-based currency such as credit cards, debit cards, smart cards, stored value cards, and the like, as known to those of skill in the art.

Vendable products acceptor 18 and payment card acceptor 24 may be the same acceptor and may be a reader capable of reading one or more of credit cards, debit cards and vendable products 12. Examples of such readers may include magnetic stripe readers, smart chip readers, and the like.

Vending machine user interface (VMUI) 20, may allow a user to interact with vending machine 10. Substantially any functionality of vending machine 10 may be available to users of vending machine 10 via VMUI 20.

VMUI 20 may comprise one or more mechanical keys, one or more touchscreen screens (which screen 300 may be), one or more computing device screens (which screen 300 may be) with one or more user interface elements (such as links, buttons etc) that may be interacted with by a user and one or more user input devices (such as a computer mouse, keyboard or the like).

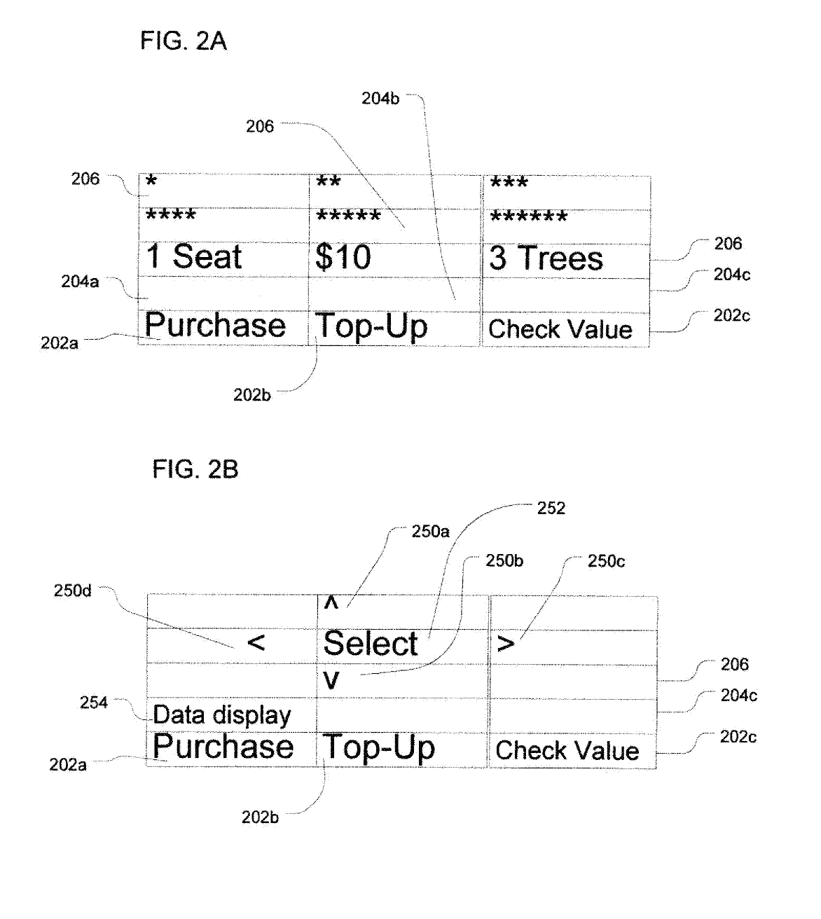

Exemplary VMUI 20 may be shown in FIGS. 2-5.

Communication interface 26 may allow vending machine 10 to communicate beyond vending machine 10, such as to any one or more components of system 700 such as environmental certifier 702, system provider 706 and travel provider 714. Such communication may be as described herein, such as to facilitate functionality of vending machine 10 or configure vending machine 10. Communication interface 26 may be any type of interface, for example a wireless network device, one or more USB ports, one or more Ethernet adaptors, one or more Firewire ports, or any other communication interface. Communication interface 26 may allow communication with any form of communication network 704 such as a wireless networks (such as cellular or IP based networks), WANs, LANs, or any other form of communication network. Vending machine 10 may have one or more communication interfaces 26, as required.

In one embodiment, communication interface 26 may be a wireless network card that allows vending machine 10 to communicate with one or more wireless networks that may be present in, for example, an airport where vending machine 10 is located. Such may allow, for example, data to be communicated to and from the Internet and any amalgamation server, and may allow one or more VMUI 20 to be provided to vending machine 10.

Receipt printer 28 may print any document required by VM 10. Such may include an acknowledgement, a receipt for expense or tax purposes, a paper to serve as vendable product 12, or any other printed material. Receipt printer 28 may receive some or all of the data to be printed from VM 10 or from any components of system 700. Such may include vendable products identifier 606.

Exemplary Views for Accessing Functionality of Vending Machines and Systems Described Herein

FIGS. 2A-B are diagrams of embodiments of VMUI 20A and VMUI 20B for vending machine 10 according to the invention. VMUI 20A and VMUI 20B may allow a user to access or perform the functionality of vending machine 10.

VMUI 20A may comprise one or more vendable products selection 206, and selections 204a,b,c. Vendable products selection 206 may allow a user of vending machine 10 to select what vendable product they wish to purchase. Vendable products selection 206 may display data that may identify to a user what vendable product they would be purchasing if they select it. By way of example, vendable products selection 206 may display a number of “*”s or other symbols that indicate a product (such as the amount of carbon offset, for example on a designed scale, that is the value of vendable product 12), how much carbon offset vendable product 12 is (such as 1 seat on an airplane or bus), a dollar amount for vendable product 12 (such as $10), a destination (“Chicago”, “New York”, “Ottawa” etc, where VM 10 may have knowledge of what airport it is in) or an environmental indicator (such as the number of trees that can be planted by someone purchasing vendable product 12). It is to be understood that vendable products selection 206 allows a user to knowingly select a product to purchase and any manner of identifying, describing and facilitating this is within the scope of the present invention.

Selections 204a,b,c may allow access to other functionality (such as if vending machine 10 later is expanded to provide more functionality) or may display information to a user based on, or responsive to, a selection the user makes. Such displayed responsive information may be a purchase price (such as if a user selects a 1 “*” item but a dollar amount is not displayed). Selections may also display information based on, or responsive to, a user selecting purchase 202a, top-up 202b and check value 202c. Such information may include a purchase price, a top-up amount to enter or entered (such as via vendable products acceptor 18), or a value on vendable product 12.

VMUI 20A and VMUI 20B comprise function selections 202 which may include purchase 202a, top-up 202b and check value 202c. These may allow a user to perform or access functionality of vending machine 10, as described herein.

VMUI 20B may comprise direction selections 250a,b,c,d which may allow a user to toggle through functionality and/or vendable products 12 that a user may purchase. For example, they may allow a user to scroll through vendable products 12 and data display 254 may display information relating to, for example, their current selection, such as pricing for that vendable product.

Data display 254 may be substantially any manner of display that may be interactive, such as a LCD display, or simple display as would be known to those skilled in the art.

Select button 252 may allow a user to select functionality and/or vendable products 12 after such has been toggled to. This may be used to indicate a selection has been made and allow a transaction to proceed.

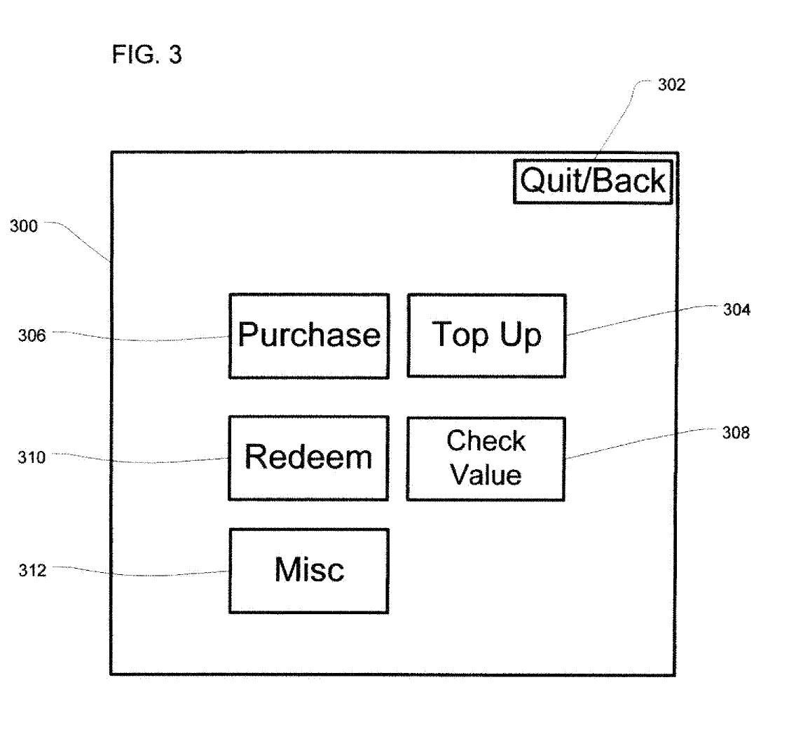

FIGS. 3-5 are diagrams of an embodiment of user interfaces 20 according to the invention. FIGS. 3-5, and in particular screens 300 may be displayed on VMUI 20. Screens 300 may also be displayed on one or more other screens, such as on web pages that may be displayed on computing devices such as laptops, PCs, travel provider 714 computing devices, mobile devices (Blackberries™, iPhones™, iPods™, cell phones), server computers, and the like. Such screens (for computing devices other than VMUI 20 and vending machine 10) may be identical to screens 300 or may be adapted for another environment (such as to make use of different processing or memory capabilities, higher resolution screens, or communication network differences that may allow screens 300 or related data to be more easily transmitted) and may be used to perform or access one or more of the functionality of vending machine 10 as described herein. By way of example, if a user wanted to top-up value on vendable product 12, they may access screens 300 and functionality of vending machine 10 from a computing device (on, for example, one or more web pages) and enter credit card information to allow a top-up. When a user next takes vendable product 12 to vending machine 10 or redemption terminal 720, the value added via the computing device could be added to the card, or redeemed. Alternatively if an account is used, perhaps instead of a tangible vendable product 12, this extra step may not be required.

Referring to FIG. 3, screen 300 of VMUI 20 comprises quit button 302, and one or more functionality buttons such as top up button 304, purchase button 306, check value button 308, redeem button 310 and miscellaneous button 312.

Functionality buttons may allow a user to access functionality of vending machine 10. This may be accomplished by displaying a further one or more screens 300 to a user, or other steps.

Quit button 302, which may appear on any screen 300, may send a user back to an introduction screen (not shown), which may be a flash screen or the like, which may present a logo, general information about one or more companies such as travel providers 714, or other information.

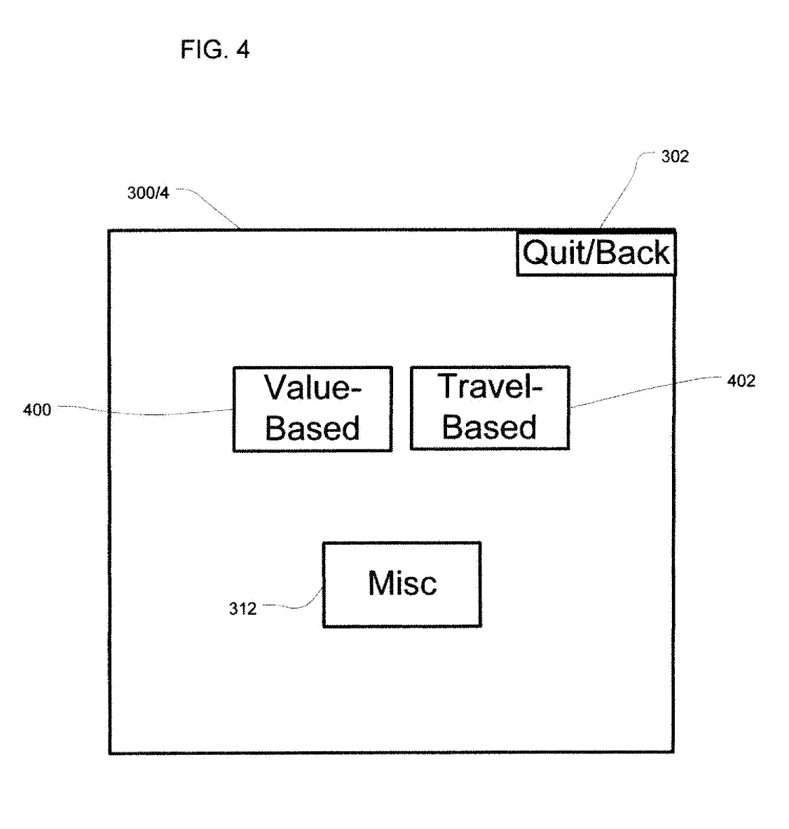

Top-up button 304 may allow accessing functionality to top up vendable product 12. Selecting top-up button 304 may then cause a further one or more screens 300 to be displayed to continue performing top-up functionality, such as screen 300 in FIG. 4.

Purchase button 306, may allow accessing functionality to purchase vendable product 12. Selecting purchase button 306 may then cause a further one or more screens 300 to be displayed to continue performing top-up functionality, such as screen 300 in FIG. 4.

Check value button 308 may allow accessing functionality to check the value of vendable product 12. Selecting check value button 308 may then cause a further one or more screens 300 to be displayed to continue performing check value functionality, such as screen 300/4 in FIG. 4.

If screen 300/3 in FIG. 3 is accessed other than by a user at vending machine 10 (such as a user at home on a personal computer) some of the functionality of vending machine 10 may not be completely accessible. For example, to complete topping up vendable product 12 may require vendable product 12 to be inserted into vending machine 10. As such, a user may be able to top up the value of vendable product 12 from another computing device (such as by providing their credit card number in a secured e-commerce screen, not shown) and such value may actually be added or written to vendable product 12 when such vendable product is inserted into, or otherwise provided to, vending machine 10 the next time (or may simply be added to the account related to vendable product 12). This may be done, for example, by the user specifying an identifier (such as vendable products identifier 606a/606b) of vendable product 12 when they top up the value and provide their credit card information from home. Then, when vendable product 12 with the specified identifier is provided to any vending machine 10, vending machine 10 may recognize such and top up the value. This may involve VM 10 checking a database in data stores 710 of vendable products 12 ready to be topped up. This may be indicated to a user that inserts vendable product 12 so that they are aware of the top up that was added remotely. This may be done via one or more screens 300. Such functionality may allow remote topping up and may allow parties other than the owner of vendable product 12 to add value. This may be done, for example, by a friend as a gift, a corporation providing such value to travelling employees, or by a corporate sponsor or advertiser who may wish to show the user one or more advertisements in exchange for adding such value. Such advertisement may be put on vendable product 12, may be shown on VMUI 20 when vendable product 12 is inserted into vending machine 10. Alternately the advertisement may be shown on a user's PC the next time they access a particular web page (such as the sponsor's or a system provider's website) may be emailed to an email address associated with vendable product 12, or may be sent to a user's address that is associated with vendable product 12.

Redeem button 310 may allow accessing functionality to redeem value on vendable product 12. Selecting redeem button 310 may then cause a further one or more screens 300 to be displayed to continue performing redeeming functionality, such as screen 300 in FIG. 4.

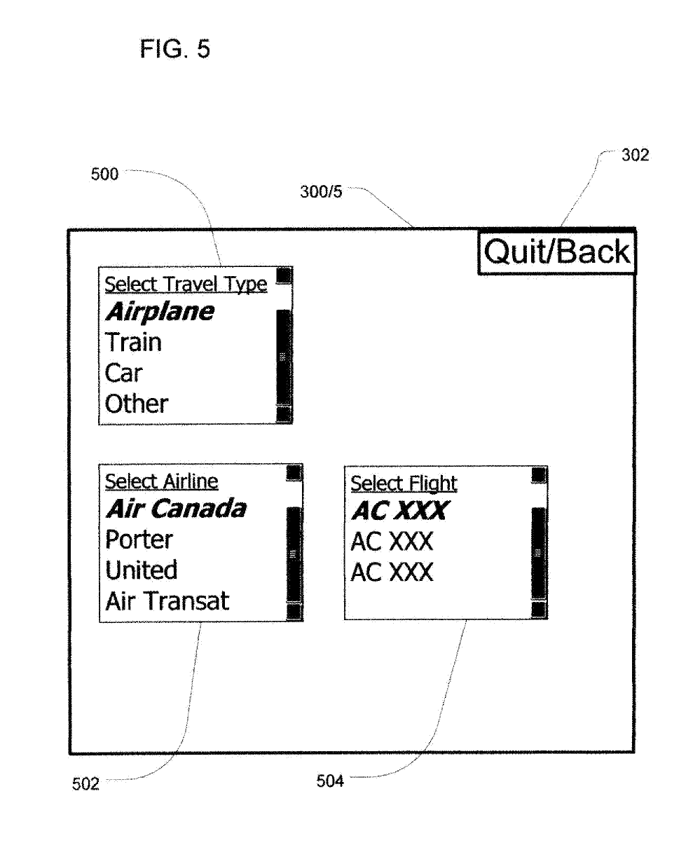

Miscellaneous button 312 may allow accessing other functionality of vending machine 10 or relating to vending machine 10 (to top up vendable product 12. Selecting top-up button 304 may then cause a further one or more screens 300 to be displayed to continue performing top-up functionality, such as screen 300/4 in FIG. 4 and 300/5 in FIG. 5.

Referring to FIG. 4, screen 300/4 of VMUI 20 comprises quit button 302, miscellaneous button 312, value-based button 400, travel-based button 400.

Quit button 302, miscellaneous button 312 may be substantially as described herein. Value-based button 400 may be selected by a user to continue with the selected functionality (such as from screen 300/3) in a value-based manner. This may mean checking their value in a monetary sense, topping up COC 12 based on adding a dollar amount, and the like. Travel-based button 402 may be selected by a user to continue with the selected functionality (such as from screen 300/3) in a travel-based manner. This may mean checking their value in a way that indicates how many travel products they can still offset, topping up COC 12 based on adding one or more travel products, and the like.

A selection from screen 300/4 may allow functionality to be continued and may display screen 300/5 in FIG. 5.

It is to be understood that such screens 300, the order they may be accessed, and the manner by which they may be accessed is exemplary only and they may provide the desired functionality in substantially any way.

Referring to FIG. 5, screen 300/5 of VMUI 20 comprises travel selection 500, travel provider selection 502, and travel product selection 504.

User screen 300/5 may be presented after a user selects one or more functionality buttons, for example from user screen 300/4, such as purchase button 306 or redeem button 310. User screen 300/5 may thus allow a user to continue to top-up or add value, check the balance or value on vendable product 12 such as COC.

Continuing to access such functionality may involve a user selecting a travel type (such as airplane, train, bus or car) such as via travel selection 500, a travel provider 714 (such as Porter, Air Canada, or American Airlines if “Airplane” was selected) such as via travel provider selection 502, and a travel product (such as AC 593 if Air Canada was selected) such as via travel product selection 504. Although depicted largely as passenger air travel, travel provider 714 may also be one or more companies that are messengers, deliverers, offer delivery service, governmental organizations (or governments) or transport goods (such as FedEx™, Canada Post™ or other such travel providers 714). Such travel providers 714 may have one or more vendable products 12 that may track carbon offsetting for the company, one or more planes in the companies' fleet, and/or one or more pilots or other employees of the company.

As described herein, each of travel selection 500, travel provider selection 502, and travel product selection 504 may facilitate a user to select a travel product. Each may obtain their selections from external sources or may be a pre-determined list selected from one or more pre-determined lists. By way of example, travel selection 500 may be filled by a pre-determined list as shown in user screen 300/5. Based on a user's selection with travel selection 500, a pre-determined list may populate travel provider selection 502. As shown in user screen 300/5, “Airplane” may be selected (as shown in bold, though other selected indicators, such as highlighting, may be used). Such selection may populate travel provider selection 502 from a pre-determined list, as shown in user screen 300/5. If a user selected “Train” in travel selection 500, then travel provider selection 502 may be populated with a pre-determined list that includes VIA, CP, Amtrak and other railways. External sources may be system provider 706, travel provider 714, or one or more sources of travel information, as described herein. In one embodiment, travel product selection 504 may be populated from a source from travel provider 714, as described herein, and may be a news source, or a source of travel information or flight information that may be part of travel provider's 714 internal systems, such as their intranet.

As a further example of obtaining selections from external sources, a user may select their form of travel using travel selection 500 or have their form of travel selected for them by external sources. Any way of having such selection occur is within the scope of the present invention, including touching a screen (for example of an iPod Touch™ or iPhone™, using a mouse or other pointing device, a scroll-wheel, having a Bluetooth™, or other local network or transmitter including a Speedpass™ transceiver, source present an option for the user (such as a Bluetooth transmitter at a gate in an airport), having a GPS device determine what environment or location a user is in (at a gas station, in an airport, at a train station, etc). A user may confirm a selection made automatically or manually.

Continuing with the above examples, a user may select their travel provider or have their travel provider selected for them, from external sources. Such may occur via a Bluetooth™ or other local network or transmitter, a GPS, or a screen prompt or interaction. Similarly, a travel product selection may be made by a user or by external sources, or a combination of both. Such travel provider selection may, for example, associate a location or transmitter with one or more of a travel provider or travel selection. It is to be understood that a user may be involved in confirming any of the details that an external source selects or selecting amongst one or more options that an external source presents.

In another example, if a user selects a mode of travel (for example selecting “Airplane” in 500) user screens, optionally in conjunction with one or more of travel provider or system provider (or an airport database) may attempt to retrieve travel information automatically from, for example, databases at such sources or flight schedules or logs, or from Bluetooth™ or other LAN connections that provides the info (such as if in a waiting area the LAN knows you are waiting for an Toronto-Ottawa flight, and asks the user to confirm this).

In yet another example, if a user is in an airport and using a computing device with a camera or bar code scanner they may be able to scan or image the boarding pass (including the bar code and/or other details) and the needed information will be retrieved by the computing device or in conjunction with one or more other parties. If the user is at a gas station, the image can be of an amount of gas and then similar things happen.

Such selections may allow a user to continue to determine how much value would need to be redeemed or purchased for such travel product, for example to carbon offset at least a portion of a user's ticket for such flight. They may then provide such compensation to VM 10 or redeem such value.

Such selections may further lead to one or more additional screens (not shown) that allow interfacing or integrating with travel provider 714 web pages or other screens to purchase carbon offsets (such as of environmental certifier 702). For example, if an Air Canada™ flight is selected in FIG. 5 then one or more Air Canada web pages (or affiliates etc of Air Canada that may be used to purchase carbon offsets) may be displayed on VM 10. This may allow travel provider's 714 system to be used, while system provider 706 may also be involved, for example in tracking this data along with other travel products (potentially from other airlines) the user has purchased, or being involved in receiving payment (such as if a user wishes to pay in currency) or using COC 12. Such screens may ask a user to enter a travel provider 714 or other loyalty program number (such as Aeroplan™, AirMiles™, StarAlliance™ etc), a travel provider 714 or other frequent flyer number (again such as Aeroplan™, AirMiles™, StarAlliance™ etc), credit card information, email address used by one or more travel providers 714, or other information or identifier used by travel provider 714 or other entities (“travel provider program customer identifier” or “TPPCI”) to allow travel provider 714 system (including AirMiles™, Aeroplan™ etc) to associate the carbon offset with the customer. Such screens (from travel provider 714 for example) may be modified to allow entering system provider customer identifier (“SPCI”) (which may be the same as vendable products identifier 606a/606b or may be different). This may allow the relevant data to be capture in both travel provider's 714 systems and system provider 706. Alternatively, data may be provided to system provider 706 from travel provider 714 screens using a lookup to a database that relates one or more TPPIs to SPCI. An example of such a table is shown below.

| | Travel | |
|---|---|---|
| SPCI | Provider | TPPCI |
| GNG1234 | Porter | P1234 |
| | Airlines | |
| | Air | AC1234 or |
| | Canada | SA 1234 |
| | Asia Miles | AM1234 |

Alternatively, such selections may lead to further screens (not shown) that may be provided by system provider 706 or stored locally on VM 10 (it is to be understood that all screens 300 may be stored locally or at system provider 706) to allow a customer to enter their TPPCI and/or SPCI. This may allow system provider 706 to provide travel information to travel provider 714 in a way that does not require much integration with system provider's 714 systems. Having a user enter data, such as one or more identifiers, may be via a touchscreen keyboard on one or more screens 300, a keyboard attached to VM 10 and/or redemption terminal 720, or VMUIE.

Vendable Products/COC

FIGS. 6A-B are schematic diagrams of the front and back of an embodiment of vendable product 12 according to the invention. FIG. 6A is an exemplary view of the back of vendable product 12 and FIG. 6B is an exemplary view of the front of vendable product 12. Vendable product 12 may comprise one or more data carriers 600 such as magnetic stripe 600a or data chip 600b, value indicator 602 and vendable product design 604.

Vendable product 12 may be substantially as described herein and may be a COC. Vendable product 12 may be a new or existing COC. If vendable product 12 is an existing COC, it may be, for example, an Air Miles™ card, a travel provider loyalty or frequent flyer card (not shown, but such as an VIPorter™ card).

Vendable product 12 may be a new card that uses existing data (such as users' data such as names, contact information, and some rewards or loyalty points) that has been collected, for example by travel provider 714 or by another party (such as Air Miles™ data). Existing data may be augmented by data relating to the present invention, such as travel information, statistics about a user's environmental currency such as carbon offsetting, and the like, as described herein.

In one embodiment, travel provider 714 may have a loyalty or frequent flyer card that customers already have. Such card may allow tracking, for example, of the number of flights a user has taken with such travel provider 714—allowing them to accumulate points or reward incentives. In such an embodiment, these cards may begin to perform additional functionality such as related to the present invention—topping up value, checking value, and other functionality as described herein, relating to environmental currency such as offsetting the carbon footprint of their travel. The systems presently used for such cards (scanning systems, POS systems, systems to allow inputting of travel undertaken in earning points, etc) may be used, supplemented or amended to allow the further functionality required. In one exemplary embodiment machines operated by travel provider 714 employees may only be used to read COC 12 and may not allow value to be added thereto. In such an embodiment, one or more vending machines 10 may be provided to allow further functionality and to ensure that travel provider 714 employees are not prevented from doing their current job. Vending machine 10 may be operated substantially without travel provider 714 or its employees.

Travel provider 714 may offer incentives for customers who purchase environmental currency such as carbon offset products. Such incentives may include discounts on the purchase of travel products, accumulation of points towards discounts on the purchase of travel products, or other incentives. Such incentives may be provided based on a single purchase of carbon offset products (for example each time a travel product is completely offset through the purchase of a carbon offset product), or as a result of more than one purchase of carbon offset products (for example if a user reaches a benchmark for carbon offsetting their travel—such as a “Carbon Offset Month” reward or a “5 Flights Offset In A Row” reward).

A user may arrive, for example, at the airport with their COC (new or existing). When checking in with travel provider 714, they may present their COC. Travel provider 714 may use COC to assess frequent flyer points to the user, as a boarding pass is being provided. When this occurs, travel provider 714 may ask the user whether they wish to redeem value to carbon offset their flight. If so, this amount may be removed from the user's card, or travel provider's system (or system provider's system) may allow value to be added or payment to be made to allow carbon offsetting the user's flight.

In an alternate embodiment, the user may top-up the value on their card, or check the value on their card, at vending machine 10 prior to checking in to make sure they have enough value to offset their travel.

Data carriers 600 may be any manner by which data can be stored on or accessed from a vendable product 12 such as COC. Data carriers 600 may allow such storage or access in a simple and time-efficient way. By way of example, it may be preferable for data carrier 600 not to require manual connection of wires to allow storage or accessing data. As such RFID, magnetic swipe or other such approaches may be used. Data carriers 600 may be in machine readable form, human readable form, or a combination thereof. Data carriers 600 may include vendable products identifiers, stored on or written on, in human readable or machine readable form (or both).

Data carriers 600 may carry at least one piece of data and may contain one or more pieces of data including a user's personal information, travel information, carbon offset statistics and/or data relating to one or more loyalty programmes or frequent flyer programmes. In an alternate embodiment, data carrier 600 may contain one or more ways for data to be accessed, such as links to websites (where the websites may be personalized and may contain personalized data), identifiers that allow vending machine 10 or other systems to access data from other storage such as data stores 710, which may be local to vending machine 10 or another system, or remote and accessed for example via communications interface 26).

Vendable product 12 may have data on or relating to one or more “accounts” such as a customer's personal travel and related travel information (which may include carbon offset information) and the same customer's corporate travel and related travel information. This may allow a user to not have to carry or use two different vendable products 12 such as two COCs. These one or more accounts may also be one or more individuals in an organization, for example. Essentially these one or more accounts may be on one COC whenever such is desirable.

Data carriers 600 may be a magnetic stripe, such as magnetic stripe 600a, as are known to those of skill in the art. Data carriers 600 may be data chip 600b, which may be a smart chip, a memory chip, a bar code an RFID transceiver, flash memory, solid state memory, a combination of all or any of the above, or any other means now known or later developed in the art for storing data such as value-related information that may include balance information, personal information, transaction histories, and the like.

Value indicator 602 may indicate a value on vendable product 12, or required to purchase vendable product 12. Value may be indicated in different currencies, as described herein. Such value indicator may not be present, or may not represent the current value on vendable product 12. For example, if vendable product 12 is being sold at an airport in Toronto, value indicator 602 may read “Ottawa” to indicate that vendable product 12 will offset a flight to Ottawa (possibly a return flight). Value indicator 602 may be printed by printer 28, such as if a printed paper is vendable product 12, or when an acknowledgment or receipt is provided by VM 10.

Vendable product design 604 may be one or more designs on vendable product 12. Vendable product design 604 may be one or more logos, such as of travel provider 714, a name of the program implementer, or a user's company (such as if the company is sponsoring the user to offset their carbon footprint). Vendable product design 604 may be a design or logo describing or advertising the movement towards carbon offset or environmentally conscious travel.

Vendable products identifier 606a/606b may identify vendable product 12, for example to one or more components of system 700 as described herein. This may be unique identification. Vendable products identifier 606a/606b may be in human readable form (such as vendable products identifier 606a), or computer readable form (such as vendable products identifier 606b).

Vendable products identifier 606a/606b, and its format, may provide information about vendable product 12. For example, vendable products identifier 606a/606b of “YYZYOW2WRD12345” may indicate it was purchased in Toronto (“YYZ” being Toronto's Pearson Airport's code), for an offset to Ottawa (“YOW” being Ottawa's International Airport), a return flight offset (“2W” instead of “1W”), research and development carbon offset products were purchased (“RD”) and the numerical identifier “12345” may further identify vendable product 12.

Vendable products identifier 606a/606b may be used synonymously with such terms as “account”, “profile”, “customer identifier”, and the like. This may be the case if it identifies both vendable product 12 and an account. Alternatively there may be a separate system provider customer identifier (SPCI) that may be the account identifier that may have one or more vendable products identifiers 606a/606b that the customer has purchased. In one embodiment, vendable product 12 may be purchased and may have vendable products identifier 606a/606b that can then be associated with a customer, company etc. In another embodiment, vendable product 12 may not be necessary to purchase and track carbon offset data, and vendable products identifier 606a/606b may simply allow one or more components of system 700 to identity what entity “owns” the account. Such vendable products identifier 606a/606b may even simply be an email address, Facebook™ profile, travel provider programme identifier, or the like. Further, vendable products identifier 606a/606b may allow redemption or activation of vendable product 12. This may be accomplished by vending machine 10 providing vendable products identifier 606a/606b to one or more components of system 700 or by a user entering vendable products identifier 606a/606b into a web page associated with one or more components of system 700 (such as a web page of environmental provider 702). Vendable products identifier 606a/606b may be covered when purchased, and may require scratching off a covering layer (not shown) to make visible and allow redemption or activation. Allowing a reader to read vendable products identifier 606a/606b may also allow activation, such as by vending machine 10 (and in particular vendable products acceptor 18) or redemption terminal 720.

Vendable product identifier 606a/606b, as described herein, may be an identifier of a person, user, customer, company or other entity. Vendable product identifier 606a/606b may not be directly affiliated with a particular vendable product 12 but may be affiliated with a user account, or another tangible or intangible item that can be used for purchasing, redeeming, tracking and reporting about carbon offsets purchased for travel products.

System for Carbon Offset Purchase and Tracking

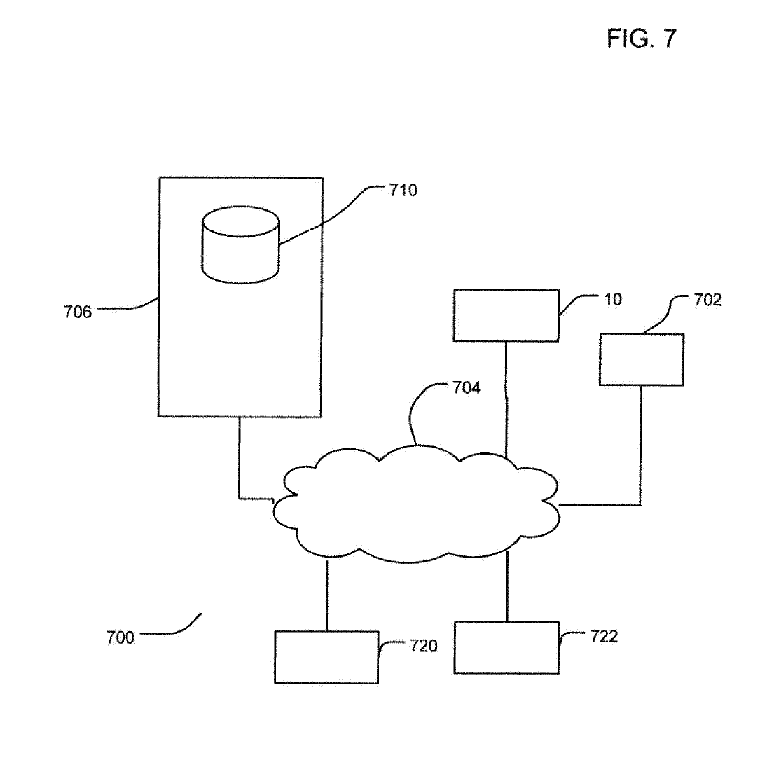

FIG. 7 is a schematic diagram of an embodiment of a system for environmental currency purchasing environmental currency according to the invention. System 700 comprises vending machine 10 which further comprises one or more vendable products 12, one or more communication network 704, system provider 706 further comprising data store 710, redemption terminal 720, and environmental certifier 702.

In a first time use of system 700, a user may go to the location of travel, which may also be a location of travel provider 714. This may be, for example, an airport and an airline, such as Porter Airlines™ at Toronto's Island Airport or Air Canada™ at Pearson Airport. A user may then visit vending machine 10 to purchase vendable product 12. Interacting with vending machine 10 may involve one or more user screens 300 to be provided by system provider 706 (such as from data stores 710) to VMUI 20 of vending machine 10, or such screens may be stored locally on vending machine 10, or may be occasionally updated from, for example, system provider 706 and/or travel provider 714. Such screens 300 may allow a user to select a travel product, such as a flight that they are about to take. Upon selection, vending machine 10 may provide the user's selection to system provider 706, environmental certifier 702 (or to environmental certifier 702 via system provider 706).

Vending machine 10 may then be provided with information identifying how much value (which may be money, carbon offsets, or any form of scale or criteria as described herein) a user must provide to offset their portion of travel product (or a fraction thereof, as described herein). Such information may be provided to vending machine 10 by system provider 706, environmental certifier 702 or by system provider 706 via environmental certifier 702.

A user may then provide the required monetary compensation to vending machine 10 (as described herein) to purchase vendable product 12 and the required or desired carbon offset. Upon authentication or acceptance of the monetary compensation by vending machine 10, the value may be loaded onto vendable product 12, such as by swiping vendable product 12 (for example if it has a magnetic stripe, such swiping may occur before or after providing monetary compensation and/or authentication) or the appropriate vendable product (with the right amount) may be dispensed by VM 10. A portion of the compensation may be directed to purchase the carbon offset, such as to environmental certifier 702. The carbon offset may be purchased by one or more of system provider 706 or environmental certifier 702, which may be the same entity or may work together. Vending machine 10 may also be a writer of vendable product 12 and may create or update data stored on vendable product 12 (which may include travel information such as the flight details, how much was offset and other data).

A user may provide personal data to vending machine 10 to personalize vendable product for them (such as creating an account). Alternatively, a user may create an account at a later time, such as through one or more web pages on a web browser that may be accessible by any computing device that may access web pages. Account creation may also be via one or more computing devices of travel provider 714 (such as their self-serve kiosks where a user may create an account that can be connected to their scanned passport, the information for their boarding pass, or any other basis as described herein). Account creation may also occur at any general computing device, such as a laptop or PDA. This may occur when a user visits system provider 706 web pages. This may occur after the user has purchased vendable product 12 and/or redeemed it. In one embodiment, a user may receive vendable product 12 (which may be a printed receipt) and may be told to set up an account, by visiting a web site (which may be system provider's 706 or travel provider 714, for example, or both), if they wish to begin tracking their carbon offset products purchased. As such, user's may first notice vending machine 10 in an airport and simply purchase vendable product 12 to offset the carbon footprint of their flight. Receiving vendable product 12 and the information thereon may then prompt them to start tracking their carbon offsets and may prompt them to join a loyalty or other program in combination with beginning such tracking.

A user may already possess a vendable product 12. In such case, a user may go to the location of travel, as described herein. A user may then visit vending machine 10 to top-up value to enable the redemption of value for offsetting their travel. Alternatively, a user may already have adequate value. This may not be discovered until a user selects a flight to redeem for, at which point vending machine 10, and one or more user screens 300 may indicate whether vendable product 12 has adequate value stored thereon. Interacting with vending machine 10 may again involve one or more user screens 300. From this point, a user may interact with system 700 substantially similar to the process as described above to purchase a carbon offset product (via vendable product 12) to offset their travel product.

System 700 may allow a user to offset at least a portion of their carbon footprint created by travelling. A user may purchase vendable product 12 from vending machine 10 or may already have vendable product 12. Such vendable product 12 may have value stored thereon that the user can redeem, or the user may add value to the card, such as via vending machine 10 or as described herein. A user may be at, or near, the location where travel will commence (such as at an airport or bus station). There the user may choose to redeem at least some of the value stored on vendable product 12 to offset the travel they are about to take (such as an airline flight).

Vending machine 10 and vendable products 12 may be substantially as described herein.

Communication network 704 may allow one or more of redemption terminal 720, system provider 706, vending machine 10, travel provider to communicate. Communication network 704 may be electronic and may comprise one or more of each of WANs or LANs. Some of such WANs or LANs may be wired or wireless. Wired LANs may include USB, serial, or other wired connections. Wired LANs may further include Ethernet networks, such as between PCs, server computers, companies and the like. Wireless LANs or WANs may include Bluetooth, infra-red, RF, 802.11, or other known wireless LANs. Exemplary WANs may include the Internet, cellular telephone networks, or private networks that may belong to an entity such as a company. All of such WANs may be partially or entirely either wired or wireless.

Environmental certifier 702 may be responsible for locating environmental currency such as carbon offset opportunities and may be responsible for facilitating the purchase of carbon offsets (carbon offset products) directly from the carbon offsetting company or product. This may include locating companies that offer renewable energy, plant trees, invest in research and development of carbon offsetting opportunities or carbon footprint reduction technologies, and the like. Environmental certifier 702 may receive an acknowledgment from the environmental currency company (such as the carbon offsetting company), that may be a carbon offset product identifier that identifies the carbon offset product purchased. Such acknowledgement may be provided back to any component of system 700 and may be provided back to a customer (together with, as part of, or separately from vendable product 12).

System 700 may employ one or more environmental certifiers 702. For example, each travel provider may use a particular environmental certifier 702, there may an environmental certifier 702 for each mode of transportation or type of carbon offset product (for example different environmental certifiers 702 may be used for R&D based environmental currency products such as carbon offset products).

Carbon offset products may include companies/products that already offset carbon footprints and companies/products that are researching ways to do so. Users may be provided the option of purchasing any types of carbon offset products, and may be provided information to assist them in selecting. Providing such information may be via one or more web pages or links thereto, and such information and/or websites may be accessible, for example on vending machine 10 or on a computing device such as a user's computing device or travel provider's computing device.

Environmental certifier 702 may act substantially as a broker that further provides some form of guarantee that the environmental currency product is authentic. Environmental certifier 702 may also be referred to as a carbon product purchaser or environmental currency product purchaser.

Environmental certifier 702 may certify one or more aspects of the carbon offset calculations such as certifying the size of the travel product's carbon footprint requiring offsetting, how much carbon offsetting is attributable to a carbon offset product, and other aspects of carbon offsetting. This may involve, for example, determining the carbon footprint of a particular flight based on the flight's distance, airplane type or model, and typical characteristics of the flight (altitude, speed, weight, number of passengers etc). This may further involve determining the number of passengers on a given travel product (and hence allow calculation of a single user's carbon footprint and hence required carbon offset). This may require information from one or more of, for example, travel provider 714 or system provider 706. It is to be understood that environmental certifier may simplify such calculations and considerations as well, in the interest of implementation.

Environmental certifier 702 may be any one or more third-parties, one or more travel providers 714, system provider 706, or any other party. In one embodiment, environmental certifier 702 may be an environmental group such as WWF™, The Gold Standard™ (as described at http://www.cdmgoldstandard.org/), Zerofootprint™, the CarbonReductionFund, or Atmosfair™.

Environmental certifier 702 may also perform some or all of receiving, authorizing and effecting payment. For example, environmental certifier 702 may provide screens where a customer enters their credit card information and then they may proceed to effect the transaction. Of course, environmental certifier 702 may use their own payment authorizer 722 as well.

System provider 706 may be a party that offers such carbon offset tracking service. System provider 706 may provide VMUI 20 (or web pages to be displayed thereon) to vending machine 10 and provide content therefore (including advertisements and any information, such as flight information, that may be required to provide and create web pages or VMUI 20 as described herein), may receive payment or direct authorization of a transaction (such as with payment authorizer 722, which may be, for example, a credit card company), may initiate or cause the purchasing of, and receiving of a receipt or acknowledgment of, a carbon offset product via environmental certifier 702, may capture and track travel information, may maintain payments for various components of system 700 and may perform other tasks as required to implement the systems and methods of the present invention.

Such functionality may be provided by one or more software modules that may be configured to communicate data, over communication network 704 with one or more other components of system 700 such as travel provider 714, vending machine 10, payment authorizer 722 and the like.

Although system provider 706 is described as providing such functionality, it is to be understood that all of such functionality may be provided by any one or more of the components of system 700. Such embodiments remain within the scope of the present invention.

System provider 706 may further comprise one or more data stores 710. Data stores 710 may be used to store any data described herein, such as travel information, travel products, carbon offset products, statistics relating to carbon offsetting, formulas and algorithms for calculating carbon offset amounts, data about any one or more of the entities/systems described herein (such as travel providers 714, vending machines 10, redemption terminals 720, and environmental certifier 702). Any of such data may be stored in one or more data records that may further comprise datasets. For example, data stores 710 may include user travel information data records that may store data, such as travel information, TPPCI TPPIs or SPCI, each relating to one or more users, that may indicate whether a user has selected the travel product and whether a user has purchased environmental currency to offset the travel product, or a portion thereof. Data stores 710 may also include one or more travel provider 714 travel information data records, where each record may relate to one or more travel providers, that may include travel information, or information about travel provider 714, and may indicate whether the travel provider 714 has purchased environmental currency to offset a travel product, or a portion thereof. Data stores 710 may also further include one or more carbon offset sponsor data records, where each record may relate to one or more carbon offset sponsors, that include travel information and the like and that may indicate whether a carbon offset sponsor has purchased environmental currency to offset a travel product, or a portion thereof.

Data stores 710 may be located at system provider 706 and may be accessible by any one or more components of system 700. Such access may be controlled, for example, by system provider 706 and may be based on access techniques such as log-ins, passwords, IP address determination, session creation, and other techniques known to those of skill in the art. Data stores 710 may have both private and public areas (not shown) that have different types of information. In one example, public information may be information that anyone can see, and may include public web sites and web sites viewable on vending machine 10 and/or other computing devices. Private data may be travel provider specific data, statistical data encompassing one or more travel providers in one or more industries or summary statistical data about how many carbon offsets are being purchased, and by what people and companies. Statistics and reporting relating to the data being tracked is virtually endless and data stores 710 may be designed to acquire such data, allow manipulation of it, and further store resultant analysis thereof.

In an alternate embodiment, data stores 710 may be located at one or more other components of system 700. For example, some travel providers 714 may want to host data stores 710 that store their own data, and at least some public data. Despite the location of data stores 710, system provider 706 may have a copy thereof to facilitate report generation and statistical analysis.

Redemption terminal 720 may allow redemption of value stored on vendable product 12. Redemption terminal 720 may substantially be vending machine 10 or may be different. In one embodiment, redemption terminal 720 may be simpler than vending machine 10 and may only allow redemption of value. Redemption terminal 720 may allow a user to redeem different amounts (such as equivalent to half of their travel product or all of their travel product).

In one embodiment, redemption terminal 720 may be similar to terminals such as the Oyster™ card terminals installed on buses and at tube stations in London, England. A user may approach redemption terminal 720 and have their card read by a vendable product reader (such as a magnetic stripe reader, RFID reader, or substantially similar in operation to a reader that reads Oyster™ cards). They may further be able to specify how much value to redeem. Redemption terminal 720 may know what travel product a user is about to use (and hence what value to redeem). This may be because redemption terminal 720 is located at a gate in an airport and the next flight that is boarding is known by redemption terminal 720 and is the travel product a user wishes to redeem for. Alternatively, redemption terminal 720 may be on the vehicle (such as on the airplane) and the user may redeem when on the plane. Redemption that occurs on the airplane may be communicated back to the required components of system 700 when the airplane is next on the ground or next at the airport of departure, for example, or when communication interface (which may be part of redemption terminal 720) is able to communicate. Redemption terminal 720 may, however, also allow selection of a travel product to redeem for, similar to vending machine 10.

Payment authorizer 722 may be any entity that ensures that payment has occurred. This may involve credit card authorization and charging (as is known in the art), debit card authorization and charging, smart card debiting, cash verification, personal cheque verification, or other authorization. Payment authorizer 722 may be, for example, a bank or other financial institution, a credit card provider, or another party. Payment authorizer 722 may have systems that allow system provider 706, or any other component of system 700, to electronically authorize a transaction.

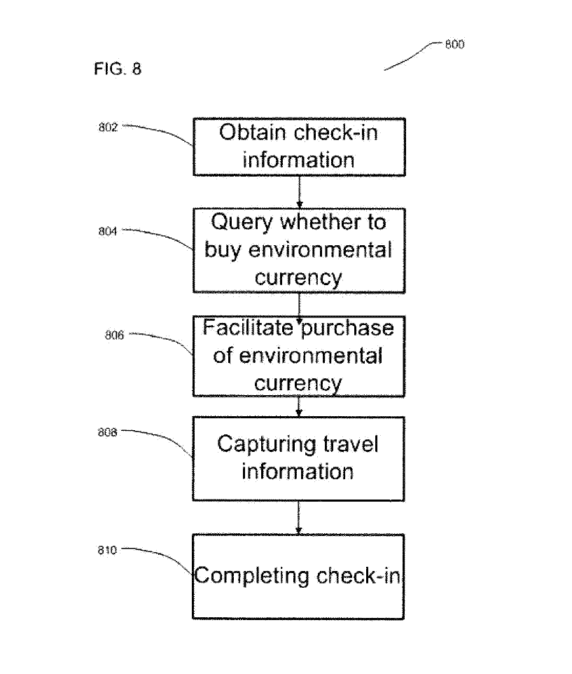

FIG. 8 is a method 800 for checking in for a travel product. Method 800 may be implemented, for example, by one or more of travel provider 714, system provider 704, environmental certifier or carbon offset sponsor. It is to be understood, with respect to the present figure but also throughout this application, that reference to various parties also may refer to servers of the particular party (ie reference to system provider 704 may be taken as referring to system provider server). Method 800 may be implemented by presenting one or more user screens to one or more of the above-mentioned parties, using servers at one or more of the above-mentioned parties.

Method 800 begins at 802 where check in information is obtained from a user of the travel product. This may be done, for example, by travel provider 714 or system provider 706. Obtaining check in information may involve getting a user's identification, such as a passport, COC, driver's license, or other information to identify the user.

At 804 a query is made to determine whether environmental currency is to be purchased. This may involve determining whether the required amount of environmental currency has been purchased for the travel product, whether the entire travel product has been offset via environmental currency purchase, or whether a portion has been offset, such as one user's portion. This may also involve determining who made the purchase of the environmental currency, such as the user, travel provider 714, or carbon offset sponsor. Determining, at 804 may involve querying system provider, travel provider or another server to see what environmental currency has already been purchased for the travel product. If, for example, a corporate sponsor had already purchased environmental currency to offset the entire flight, then the query at 804 would result in no environmental currency being required. In another example, the user's corporation may have already offset the user's portion of the flight, or may do so at a later time. If the user's portion of the travel product has not been offset through the purchase of environmental currency then the user may be asked whether they want to purchase such environmental currency. Such may be done via one or more user screens on one or more parties' servers.

At 806 the method facilitates purchasing environmental currency. Such may be accomplished in any of the approaches as described herein.

At 808 travel information may be captured. It is to be understood that this step need not happen, but may allow integration into other initiatives, such as travel provider's frequent flyer programs, providing the user's information to a corporate sponsor program (such as one that keeps track of where a user is flying so that companies in the destination city can advertise with the corporate sponsor, or instead of the corporate sponsor) aspects of the present invention for tracking a user's travel information, and other such initiatives.

At 810 check in may be completed. This may involve, for example, printing a boarding pass that may have an advertisement of the purchaser of the environmental currency, or an indicator of whether that seat has been offset (by any purchaser, such as a corporate sponsor). An indicator may include a colored portion of the boarding pass, green for example. Any other indicator may be used and may encourage people that are using the travel product to relate to those around them that also have offset their travel product. Check in may also be completed without printing a boarding pass. One such way is to provide an electronic boarding pass to a computing device, such as a user's computing device (PDA, Blackberry™, cell phone, iPod™ or iPhone™, etc), for example via SMS, email, or via a user screen a user can access. An indicator, or advertisement, may further be included in such an electronic boarding pass. Check in completion may also include a user's profile (as described herein) being altered to indicate the purchase of the environmental currency, or the fact that the user's portion of the environmental currency for the travel product has been purchased. Where a user has a computing device with them, whether an electronic boarding pass is used or not, a user's profile may be altered based on the environmental currency for the travel product in question. This may create a social networking community of users, for example in the airport gate, that may have contributed to an offset flight, or purchased an already offset flight. This may allow further advertising opportunities or other social networking opportunities.

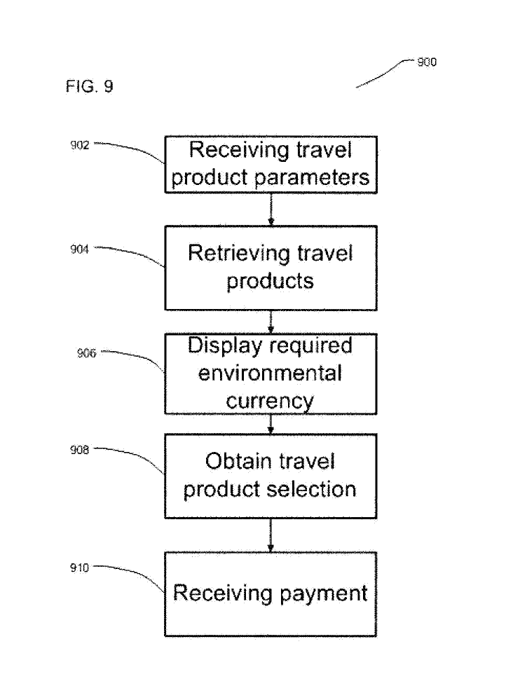

FIG. 9 is a method 900 for buying a travel product. Method 900 may be implemented, for example, by one or more of travel provider 714, system provider 704, environmental certifier or carbon offset sponsor. Method 900 may be implemented by presenting one or more user screens to one or more of the above-mentioned parties, using servers at one or more of the above-mentioned parties. Method 900 may be performed by one or more users, travel providers, and corporations.

Method 900 begins at 902 where travel product parameters are received. This may involve, for example, selecting a departure location, destination location, travel product mode (such as a flight, train, etc), a date and other parameters. Receiving at 902 may be substantially similar to selecting a travel product via websites such as Expedia.com, AirCanada.com, or other such services. It is to be understood that such websites may be operated by one or more travel providers or by a third party. In such a case, a user may be able to select, for example, between flights offered by different travel providers having the same parameters. Travel product parameters may be received, for example, from one or more users or corporations and may be received via one or more computing devices, for example via one or more user screens or websites.

At 904 method 900 continues to retrieve travel products that match the parameters received. Travel products that match may include multiple travel products from multiple travel providers.

At 906 required environmental currency required for one or more of the travel products that match the parameters are displayed. Such required amount may be the amount required for the whole travel product, a portion of the travel product, a user's portion of the environmental currency, or some other required amount. Such required amount may vary depending on various factors. When considering a flight, for example, the required amount may vary based on the number of people on the flight, the type of plane being used, the type of fuel being used, the path of travel, or whether it is a direct flight or not. Displaying the amount at 906 may allow the potential purchaser of the travel product (a user, sponsor, corporation, or any other party) to see which travel products have already been offset by the purchase of environmental currency, which requires the smallest amount of environmental currency for the user to offset their portion of the travel product, or which travel providers have been offsetting more of their travel products (such as via one or more user screens that may be presented to a user that provides statistics for a travel provider in general, not simply for the particular travel product being considered). This may allow the purchaser to make a more environmentally friendly selection of travel products that match their parameters.

At 908 a travel product is selected to be purchased. Such may be done, for example, via one or more user screens that may be presented to one or more computing devices.

At 910 payment is received for the travel product that was selected. The payment may include value or payment for the purchase of environmental currency to contribute at least a portion of the amount required to offset the travel product. The payment may be effected in any way known to those of skill in the art, including Pay Pal™, credit cards, stored value cards, COC, frequent flyer points, or other means of payment. It is to be understood that payment for the travel product and for environmental currency may be done together or separately to some extent. Further, if they are separate, an extra query may be made to determine whether, and to what extent, environmental currency is to be purchased. This may allow different amounts to be purchased, and possibly for more than one user or travel product.

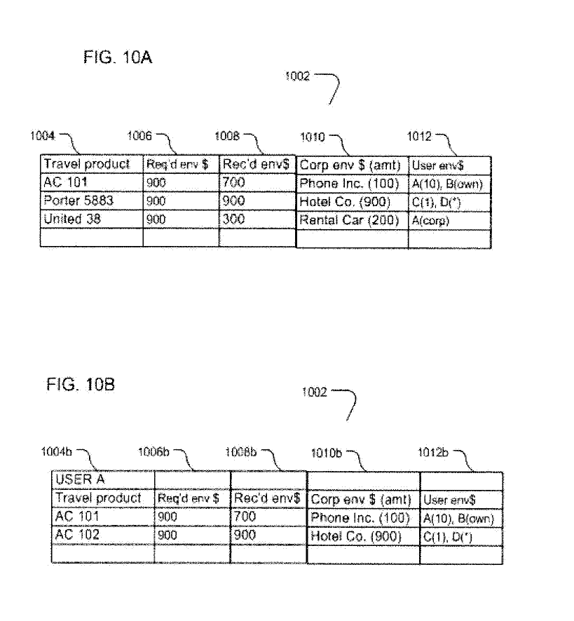

FIGS. 10A-B are embodiments of data records according to the invention. FIG. 10A is an exemplary data record of TPDR 1002 and FIG. 10B is an exemplary data record of UDR 1020.

Turning to FIG. 10A, there are exemplary travel product data records (TPDR) 1002. TPDR 1002 may be stored, for example, in storage 710 of system provider or may be on one or more other computing devices, and may be stored in duplicate. Each TPDR 1002 may relate to one travel product. As depicted in FIG. 10A, each row of a table may correspond to one travel product and one TPDR 1002. Each TPDR may contain one or more pieces of data, or datasets, relating to the travel product. Exemplary datasets may include:
Travel product 1004: this may be one or more identifiers of the travel product, such as the travel provider, a travel product identifier, and other details of the travel product.
Required environmental currency dataset 1006: this may be the amount of environmental currency required to offset the entire travel product, or one individual's portion, or some other portion of the travel product. It may further include value required, instead of, or in addition to, the environmental currency required. In one embodiment it may include both the total environmental currency (expressed as value or environmental currency) and some further value. This further value may be the extra amount that a travel provider may require for a corporate sponsor to pay—in exchange the corporate sponsor may receive adverstising (such as boarding pass indicators, in-flight announcements, connection to destination city ‘green’ hotels and car rentals, and other incentives). As such, required environmental currency data 1006 may contain the amount of compensation the travel provider requires in exchange for incentives (that are either established by the travel provider or specified by the corporate sponsor). It is to be understood that the amount in 1006 may be a minimum and may begin an auction or bid process amongst corporate sponsors—and provided via one or more user screens.
Received environmental currency dataset 1008: this may be the amount of value or environmental currency received for the travel product from one or more sources or purchasers, such as via users, corporate sponsors, or travel provider 714. This may include further information about the nature of the environmental currency, such as to allow an audit. Such datasets may be stored in a way so that the breakdown of the received environmental currency can be retrieved (such as how much came from corporate sponsors versus users, and how much was received before the travel product or flight departed, versus during or after the travel product finished or landed). This dataset may be updated, such as by adding the received environmental currency to a current total of environmental currency, for example in real-time, when a user checks in and buys environmental currency, when a corporate sponsor decides to sponsor one or more travel products, when a travel provider (optionally in the middle of the travel product) decides to purchase offsets to remove any carbon footprint caused by the travel product. Such may allow any user having access to a computing device that can access one or more user screens of system provider to see how ‘offset’ the travel product is. This may influence a user's selection of travel products matching their desired parameters.
Corporate environmental currency 1010: this may be one or more portions of the received environmental currency received 1008 that is received from one or more corporate sponsors, possibly in connection with an auction or bid process, or otherwise received. This may include further information about the currency or the corporate sponsor, but for simplicity such details are not shown.
User environmental currency 1012: this may be one or more portions of the received environmental currency received 1008 that is received from, or on behalf of (such as a user's corporation), one or more users of the travel product. This may include further information about the currency or the user, but for simplicity such details are not shown. Any of such datasets may be measured in dollars, some form of environmental currency (such as CO2) or other scheme, substantially as described herein.

It is to be understood that many other datasets may be part of TPDR 1002. Such may include the date of the travel product, source and destination cities, and other parameters upon which travel products may be searched for. TPDR 1002 may also calculate percentages of environmental currency required versus received, and be part of monitoring/calculating how ‘green’ a travel provider is—across one or more of their travel products over one or more portions of time. Such data may allow travel providers, and corporate sponsors, for example, to have an auditable trail of their ‘green’ success. Other details may be included to facilitate an auction, such as the opening and closing periods for the auction. In essence, TPDR is flexible to store and use data required to implement various aspects of the present invention.

Turning to FIG. 10B, there are exemplary user data records (UDR) 1020. Datasets 1004b, 1006b, 1008b, 1010b and 1012b may be substantially similar to those in FIG. 10A but may be organized based on the user of the travel product. Such may allow for one or more aspects of the present invention, such as tracking a user's carbon offsets.

Although not shown, there may also be travel provider data records that may have substantially similar datasets to UDR 1020 and TPDR 1002 but may be organized based on the travel provider. Such may allow a travel provider's ‘green-ness’ to be monitored, tracked, analyzed, displayed, etc.

As those of skill in the art will know, there are many ways that the data may be organized, related to each other, searched, stored and manipulated. Such approaches are considered within the scope of the present invention. The data must simply be organized to allow for one or more aspects of the present invention.

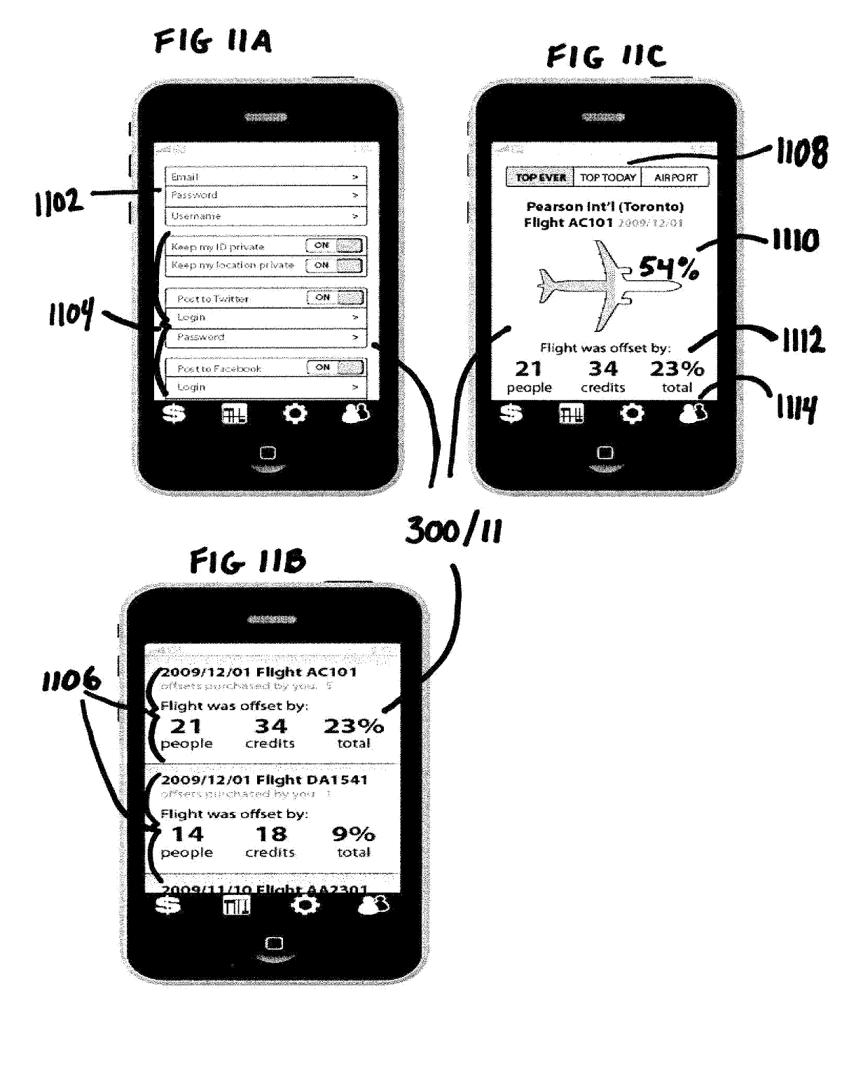

FIGS. 11A-C are exemplary user screens according to the invention. In particular, FIG. 11A provides a user screen 300/11 with user profile data, FIG. 11B provides a user screen 300/11 with a user's travel information data and FIG. 11C provides a user screen 300/11 with travel product information. It is to be understood that although depicted on a PDA (such as an iPhone) such user screens may be provided by system provider 704 to substantially any computing device used by any party over substantially any communication network. FIGS. 11A-C may be displaying some or all datasets in one or more UDR 1020 and/or TPDR 1002, or other data records, for example associated with an airport, organization, carbon offset sponsor or the like.

Turning to FIG. 11A user screen 300/11 comprises travel information 1102 and social networking information 1104. User screen 300/11 may allow a user to view or alter their profile settings. Such may include their email, password, or username as shown in 1102. Such may further include preferred travel providers, frequent flyer identifiers and other travel information as it is to be understood that the information shown is exemplary only. Social networking information 1004 may allow a user to publish their carbon offsetting to any number of social networking sites, such as Facebook™, Twitter™ and the like. Various settings may allow the user's location, for example within an airport or at a gate, to be visible to other user's of the application. Such location may be determined, for example, via GPS. Social networking, and location publishing, may allow a community of users to interact when waiting for, taking, or leaving a travel product.

Turning to FIG. 11B there may be one or more travel product data records 1106 or user data records 1106 displayed for a user to view. Such may include a breakdown of the total environmental currency purchased for the travel product as well as the user's contribution, for example. A user may therefore be able to view their history of taking travel products and of having their travel products offset (by their purchase of environmental currency or another party's purchase such as their organization, a corporate sponsor or travel provider). From such user screen a user may be able to view more details about a travel product, purchase further environmental currency to offset one or more particular travel products, view statistics of their entire travel products, or create/print an audit, for example for tax benefits or other ‘green’ benefits.

Turning to FIG. 11C there may be one or more travel product data records presented in greater detail than in FIG. 11B. Graphics such as 1110 may be used to show how close the travel product is to being carbon neutral—enticing users or others viewing such a user screen, to purchase further environmental currency. Data record 1112 may be a partial or complete data record relating to, for example, a travel product and may be substantially similar to 1106. Tabs 1108 may allow a user to search or sort through the historically most successfully offset travel products, travel providers, corporate sponsors or organizations (under the “Top Ever” tab). Tabs 1108 may further allow a user to search or sort through today's most successful offsetters, and may further allow searching by airport, city and the like. In effect, user screen 300/11 in FIG. 11C is intended to demonstrate one user screen that can organize and display travel information relating to environmental currency purchasing habits of one or more of users, organizations, corporate sponsors, travel products and travel providers. One purpose or goal of such screens may be to encourage more environmental currency purchasing by allowing greater transparency as between such groups.

Although not shown or discussed in detail herein, systems and methods herein may further include security measures. Such measures may protect data transmitted via communication network 704 (such as via encryption), access to systems' functionality (such as be log-in, passwords and the like), security of data stored and displayed on vendable product 12 (for example through encryption and passwords, keeping data in data stores 710, and covering important information prior to being sold). While these and other security features may be desirable, it is to be understood that such security features are known in the art.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A vending machine for purchasing an environmental currency product comprising:
a payment acceptor and
a vending machine user interface for selecting an environmental currency product, for a travel product, to purchase.

2. The vending machine of claim 1 further comprising a communication interface for sending and receiving data with one or more of a system provider, a travel provider, and an environmental certifier, and wherein the vending machine user interface further allows one or more identifiers to be entered that may allow tracking of travel information by one or more of a system provider or a travel provider.

3. The vending machine of claim 2 further comprising:
a vendable product holder that can hold one or more vendable products;
a vendable product dispenser; and
wherein the vending machine user interface is configured to facilitate a user purchasing a vendable product to be dispensed to the user via the vendable product dispenser by providing payment to the vending machine via the payment acceptor.

4. The vending machine of claim 3 further comprising a vendable products acceptor that comprises a reader/writer configured to read/write one or more datasets from or to the vendable product.

5. The vending machine of claim 4 wherein the vendable product may be redeemed or activated for the purchase of a carbon offset product for a travel product, and the redeeming may be performed by the vending machine upon purchase or by providing a vending product identifier to one or more of a system provider, an environmental certifier or a travel provider.

6. A system for carbon offsetting a travel product comprising:
a system provider server configured to:
provide one or more user screens to one or more computing devices used by a user of the travel product, a travel provider of the travel product or a carbon offset sponsor of the travel product,
allow selection of a travel product by one or more of the computing devices through interaction with one or more user screens of the system provider server,
arrive at the environmental currency required by the travel product,
receive, from one or more of the computing devices, environmental currency, or value used to purchase environmental currency for the travel product, and
add the received or purchased environmental currency to a total of received environmental currency for the travel product.

7. The system of claim 6 wherein the system provider server further comprises one or more travel product data records that comprise datasets that indicate what portion of a travel product has been offset by purchased environmental currency.

8. The system of claim 7 wherein the system provider further comprises one or more user travel information data records, each relating to one or more users, that indicate whether a user has selected the travel product and whether a user has purchased environmental currency to offset the travel product, or a portion thereof, and wherein the system provider is configured to receive value from the user to purchase environmental currency and include an indication of such purchase in the user travel information data record.

9. The system of claim 8 wherein the system provider server is further configured to provide one or more user screens to one or more computing devices that indicates the environmental currency required by the travel product and the environmental currency received for the travel product.

10. The system of claim 9 wherein the system provider server is further configured to provider one or more user screens to one or more computing devices that indicates the environmental currency purchased by a user to offset the travel product, the environmental currency purchased by a travel provider to offset the travel product and the environmental currency purchased by a carbon offset sponsor to offset the travel product.

11. The system of claim 10 further comprising one or more travel provider travel information data records, each record relating to one or more travel providers, that indicate whether the travel provider has purchased environmental currency to offset a travel product, or a portion thereof and wherein the system provider is configured to receive value from a travel provider to purchase environmental currency and include an indication of such purchase in the travel provider data record.

12. The system of claim 11 further comprising one or more carbon offset sponsor data records, each record relating to one or more carbon offset sponsors, that indicate whether carbon offset sponsor has purchased environmental currency to offset a travel product, or a portion thereof and wherein the system provider is configured to receive value from a carbon offset sponsor to purchase environmental currency and include an indication of such purchase in the carbon offset sponsor data record.

13. The system of claim 12 wherein the user screens are provided to one or more computing devices prior to the travel product departing.

14. The system of claim 13 wherein the user screens are provided to one or more computing devices during the travel product.

15. A method for checking in for a travel product comprising:
obtaining check-in information from a customer of the travel product,
querying whether environmental currency is to be purchased,
facilitating the purchase of environmental currency,
capturing travel information; and
completing check-in.

16. The method of claim 15 wherein querying comprises determining whether the required amount of environmental currency for the travel product, or a user's portion thereof, has been purchased and determining who the purchaser is and if it has not then asking a user if they wish to purchase environmental currency.

17. The method of claim 16 wherein completing further comprises providing the user a boarding pass wherein the boarding pass has an advertisement for the purchaser of the environmental currency.

18. A method for purchasing a travel product comprising:
receiving parameters for the desired travel product;
returning one or more travel products matching the received parameters;
displaying whether the required amount of environmental currency for each of the one or more travel products, or a user's portion thereof of each of the one or more travel products, has been purchased;
obtaining a selection of a travel product to purchase; and
receiving payment in exchange for the travel product.

19. The method of claim 18 further comprising querying whether environmental currency is to be purchased and facilitating the purchase of environmental currency.
